(19) United States
(12) Patent Application Publication
(10) Pub. No.: US 2004/0243027 A1
(43) Pub. Date: Dec. 2, 2004

(54) Repetitive motion exercise therapy device and method of treatment using same

(76) Inventor: Steven D. Hook, Delton, MI (US)

Correspondence Address: FLYNN THIEL BOUTELL & TANIS, P.C., 2026 RAMBLING ROAD, KALAMAZOO, MI, 49008-1699, US

(21) Appl. No.: 10/829,092

(22) Filed: Apr. 21, 2004

Related U.S. Application Data
(60) Provisional application No. 60/464,310, filed on Apr. 21, 2003.

(51) Int. Cl. A61H 1/00

(52) U.S. Cl. 601/33; 601/23

(57) ABSTRACT

A repetitive motion exercise therapy device is used to treat patients having stricken limbs. The exercise therapy device includes a frame assembly, a patient support assembly and a control system. The frame assembly includes at least one sub-assembly configured to support the arm of a patient. The at least one sub-assembly is configured to allow the patient arm to rotate about three shoulder axes of movement, an elbow axis of movement and three wrist axes of movement. A plurality of actuators are connected to the frame assembly. Each actuator is configured to move the sub-assembly, and therefore, the patient's arm, about one or more of the axes of movement. The patient support assembly is preferably height adjustable to allow patients of varying heights to be accommodated by the exercise therapy device. The control system preferably includes a user interface and a controller.

### CROSS REFERENCE TO RELATED APPLICATION

This application claims priority of U.S. Provisional Application Serial No. 60/464 310, filed Apr. 21, 2003.

### FIELD OF THE INVENTION

The invention relates to an exercise therapy device for rehabilitating patients, and more particularly to an exercise therapy device which uses repetitive motion to rehabilitate movement of the shoulder, elbow and wrist joints of a patient.

### BACKGROUND OF THE INVENTION

The prevailing wisdom when a patient loses mobility due to stroke or other injury is that little or no mobility will return. Traditional treatment methods are geared toward helping the patient modify their lifestyle to adjust to the loss of motion. However, this necessarily requires acceptance of impairments in lifestyle. It therefore is desirable to develop treatment methods which are able to minimize if not eliminate such impairments.

It is an object of the invention to develop a treatment method and an exercise therapy device to maximize rehabilitation of a patient, particularly with respect to improvements in motion of the patient's extremities.

### SUMMARY OF THE INVENTION

The present invention is directed to an exercise therapy device which develops and improves motion in the upper extremities of a patient to thereby improve the patient's lifestyle. The exercise therapy device includes a frame, a patient support assembly for supporting the patient on the frame and effecting controlled movement of the patient's upper extremities, and a control system for controlling such movement.

The patient support assembly includes a pair of arm assemblies projecting forwardly from the frame and adapted to support each arm of a patient. The arm assembly includes three serially-connected sub-assemblies adapted to respectively support the upper arm, forearm and wrist of the patient wherein the individual sections are articulatable to allow for movement of the patient's arm about three shoulder axes of movement, an elbow axis of movement and three wrist axes of movement. By moving the patient's arm about any combination of these axes, the exercise therapy device is designed to improve rehabilitation of the patient's extremities.

To accomplish the articulating movement of the arm sub-assemblies, each of the left and right arm assemblies includes a plurality of actuators which are operated by the control system to effect isolated or simultaneous movement of the patient's upper arm, forearm and/or wrist about the multiple axes referenced above. The patient support assembly is preferably height adjustable to allow patients of varying heights to be treated by the exercise therapy device, and the control system includes a user interface and programmable controller to allow for the automatic performance of different treatment methods.

Other objects and purposes of the invention, including structural and operational advantages thereof, will be apparent to persons familiar with constructions of this general type upon reading the following specification and inspecting the accompanying drawings.

### BRIEF DESCRIPTION OF THE DRAWINGS

FIG. 1 is a front view of a first embodiment of the exercise therapy device of the present invention;

FIG. 2 is a rear view thereof;

FIG. 3 is a right side view thereof;

FIG. 4 is a top view of one arm support assembly;

FIG. 5 is a side view of the arm support assembly;

FIG. 6 is a block diagram of the control system for the exercise therapy device;

FIG. 7 is a cross-sectional top view of a pivot connection defined between a stationary section of the frame and a swinging frame section that supports a respective arm support assembly thereon;

FIG. 8 is an enlarged top view illustrating a left arm support assembly in a rest position and a right arm support assembly rotated about a vertical first shoulder axis;

FIG. 9 is an enlarged view illustrating the right arm support assembly in the rest position and the left arm support assembly rotated about a longitudinal horizontal second shoulder axis;

FIG. 10 is an enlarged side view illustrating the left arm support assembly in the rest position and the right arm support assembly swung sidewardly about the first shoulder axis and further rotated about a longitudinal horizontal third shoulder axis;

FIG. 11 is a side view illustrating a forearm sub-assembly of the right arm support assembly pivoted upwardly about a transverse horizontal elbow axis;

FIG. 12 is a side view illustrating a wrist sub-assembly rotated forwardly about a transverse first wrist axis;

FIG. 13 is an enlarged front view illustrating the left wrist sub-assembly rotated about a longitudinal second wrist axis;

FIG. 14 is an enlarged front view illustrating a hand grip of the left wrist sub-assembly rotated about a vertical third wrist axis.

FIG. 15 is a front view of an improved second embodiment of a complete exercise therapy device. Shoulder swing assemblies are shown to represent the arm supports raised and to the side while arm supports are shown to illustrate bends at the elbow extending forward;

FIG. 16 is a side view thereof;

FIG. 17 is a top view thereof;

FIG. 18 is a side view of one shoulder swing assembly;

FIG. 19 is a front view thereof;

FIG. 20 is a top view thereof;

FIG. 21 is a side view of a horizontal travel assembly;

FIG. 22 is a front view thereof;

FIG. 23 is a top view thereof;

FIG. 24 is the left side view of the frame assembly;

FIG. 25 is the top view thereof;

FIG. 26 is a front view thereof;

FIG. 27 is a rear view thereof;

FIG. 28 is a left side view illustrating the installation location of one horizontal travel assembly and shoulder swing assembly;

FIG. 29 is a front view thereof, illustrating the location of both the left and right horizontal travel assemblies and shoulder swing assemblies;

FIG. 30 is a side view of the left arm support assembly;

FIG. 31 is a top view of the left arm support assembly;

FIG. 32 is a top view of the left arm support;

FIG. 33 is a cross sectional view illustrating the operational method for the rotary motion around the Sz axis;

FIG. 34 is a top view of the left arm support assembly illustrating the pivoting motion about the Ey axis;

FIGS. 35 and 36 are side views of the left arm support assembly illustrating the wrist pivoting action about the Wx axis;

FIG. 37 is a top view of the left arm support assembly in an initial position;

FIGS. 38, 39 and 40 are cross sectional views of the left arm support assembly as taken along line 38-38 of FIG. 37, illustrating the rotary motion about the Wz axis;

FIGS. 41, 42 and 43 are enlargements illustrating a rotary motion of the left arm support assembly about the Sz axis;

FIG. 44 is a top view of a complete exercise therapy device, illustrating the pivoting actions about the Sy axis;

FIG. 45 is a top view of a complete exercise therapy device. The shoulder swing assemblies and the arm support assemblies are drawn to represent extending both arms outwardly;

FIG. 46 is a top view of a complete exercise therapy device, illustrating the pivoting action about the Sy axis;

FIG. 47 is a front view of a complete exercise therapy device, illustrating the shoulder swing assemblies rotated to extend the arm support assemblies in front and the arm support assemblies rotated at the elbow to represent the patients fists opposing each other;

FIG. 48 is a front view of the complete exercise therapy device, illustrating the Ax axis motion;

FIG. 49 represents the construction of a typical servo drive assembly in an exploded view;

FIG. 50 is an assembly view of the components of FIG. 49;

FIG. 51 is a block diagram for the control system for the exercise therapy device;

Certain terminology will be used in the following description for convenience in reference only, and will not be limiting. For example, the words “upwardly”, “downwardly”, “rightwardly” and “leftwardly” will refer to directions in the drawings to which reference is made. The words “inwardly” and “outwardly” will refer to directions toward and away from, respectively, the geometric center of the arrangement and designated parts thereof. Said terminology will include the words specifically mentioned, derivatives thereof, and words of similar import.

### DETAILED DESCRIPTION

First Embodiment

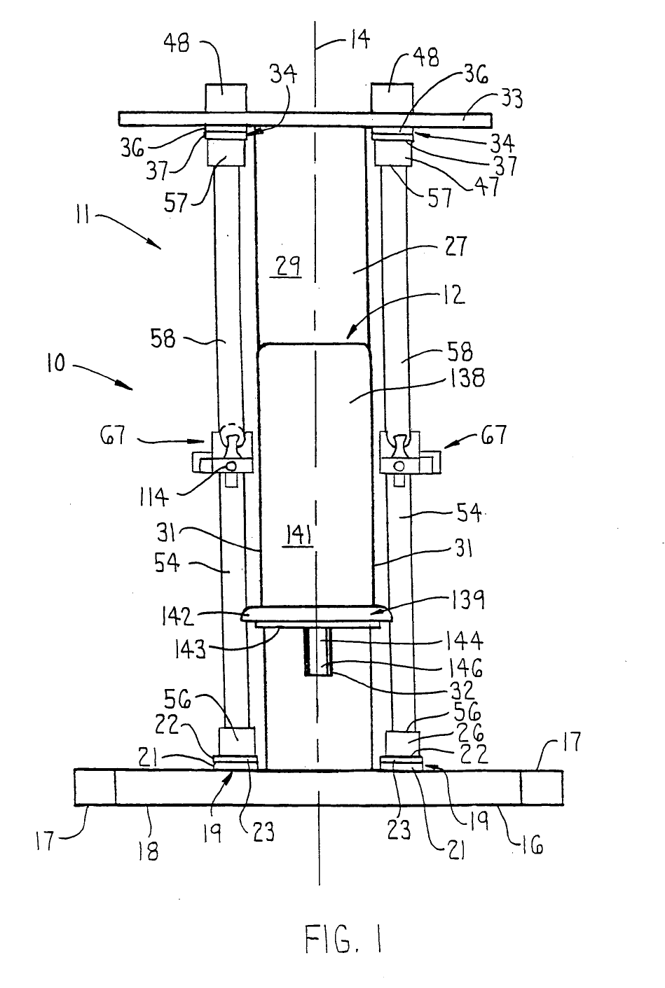

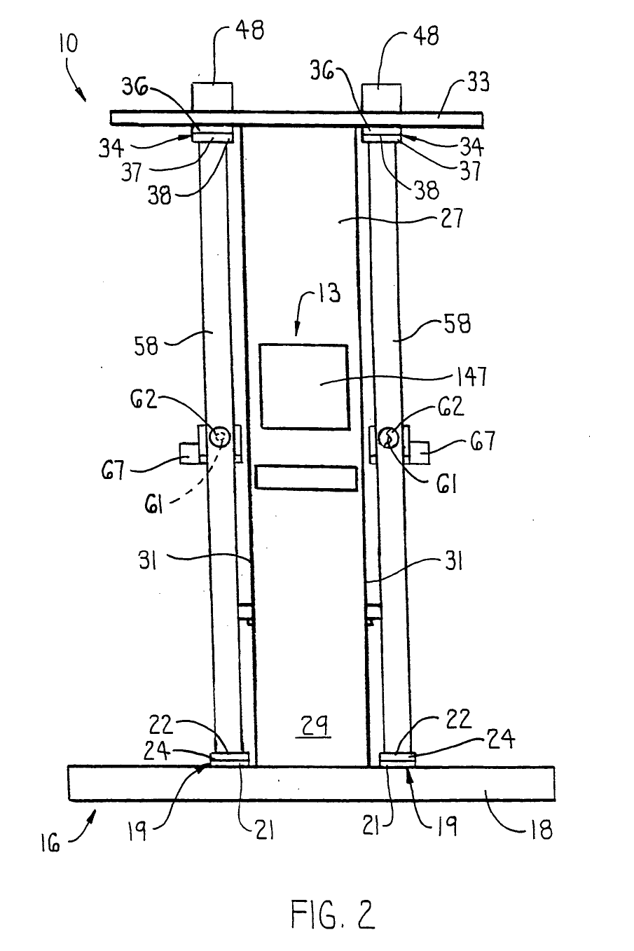

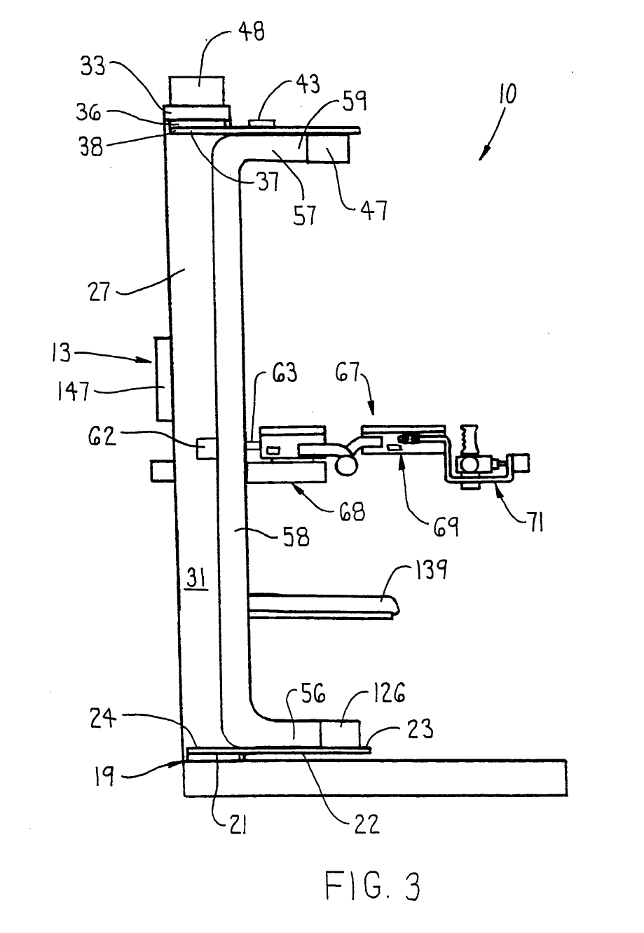

Referring to FIGS. 1-3, there is illustrated a first embodiment of an exercise therapy device 10 according to the present invention. The exercise therapy device 10 includes a frame 11, a patient support assembly 12 mounted on the frame 11, and a control system 13 (FIGS. 2 and 3). As discussed herein, the exercise therapy device 10 is symmetrical about a central vertical axis 14 to permit movement of and rehabilitation of both the left and right sides of a patient.

The frame 11 includes a generally U-shaped base 16 having first and second arms 17 which are connected sidewardly together by a central frame section 18. The base 16 is formed of a suitable rigid material, such as steel or aluminum.

A top surface of the central frame section 18 includes a pair of sidewardly spaced-apart lower post supports 19 wherein each post support 19 includes a stationary component 21 that is affixed to the central frame section 18 in a suitable manner, such as by welding. Each post support 19 further includes a lower support beam 22 that has a free end 23 projecting forwardly from the stationary component 21 and a rear attachment end 24 which is rotatably connected to the stationary component 21. The stationary component 21 and attachment end 24 include aligned bores which permit the rotatable connection of these components and define a vertical rotation axis about which the support beam 22 can be swung in a horizontal plane. The free end 23 of each beam 22 includes a sleeve or cup 26.

To support the patient support assembly 12, the frame 11 includes a hollow column 27 extending upwardly from the base central section 18 wherein the column 27 is located centrally on the base 16. The column 27 has a rectangular cross-sectional shape defined by relatively wide front and back surfaces 29 and narrow side surfaces 31. A central adjustment slot 32 extends along a lower portion of the front surface 29 of the column 27, as illustrated in FIG. 1.

A generally rectangular upper frame element 33 is supported on the upper end of the central column 27 so as to extend across the transverse width of the therapy device 10. The upper frame element 33 is formed of a rigid material and secured to the column 27 in a suitable manner, such as by welding.

Each opposite end of the upper frame element 33 has an upper post support 34 projecting downwardly from a bottom surface thereof. Each post support 34 includes a stationary component 36 and a horizontally-elongate, rotatable upper support beam 37 which is horizontally-elongate and rotatably supported on the stationary component 36. The post supports 34 are configured similar to the post supports 19 described above.

To effect controlled swinging movement of the upper beams 37, a drive arrangement is connected to each beam 37 for rotation of the beam 37 about a vertical axis. As illustrated in FIG. 7, first and second bores 39 and 41 extend through an attachment end 38 of each support beam 37. The support beam 37 includes a driven gear 42 that is non-movably positioned in alignment with the mounting bore 41. This driven gear 42 cooperates with remaining components of the drive system as will be discussed further herein.

To monitor swinging movement of the beams 37, each beam 37 includes a sensor assembly 43 (FIG. 3) proximate the driven gear 42. As seen in the block diagram of FIG. 6, the sensor assembly 43 comprises a sensor 44 which detects the angular distance the upper beam 37 rotates with respect to the stationary component 36 about a vertical first shoulder axis Sy (FIG. 8). The sensor assembly 43 also includes a transmitter 46 which transmits the data from the sensor 44 for use by the control system 13. Preferably, the sensor 44 and transmitter 46 are capable of sending and receiving RF or other remote signals.

As to the remaining structure of the beams 37, each beam 37 also includes a rectangular sleeve or cup 47 which projects downwardly from the distal ends thereof.

To control rotation of each support beam 37, first shoulder servo motors 48 (FIGS. 1-3) are positioned atop the upper element 33 in alignment with the above-described bores 39 (FIG. 7) such that a drive shaft 49 of each motor 48 projects downwardly therethrough. The lower free end 51 of each drive shaft 49 projects through the bore 41 and includes a drive gear 52 which meshes with the driven gear 42 such that rotation of the drive gear 52 drives rotation of the upper support beam 37 associated therewith about axis Sy. Each servo motor 48 includes an RF transducer 53, which is schematically illustrated in FIG. 6, to control operation of the motor 48.

The frame assembly 11 further includes left and right upwardly-extending posts 54. Each post 54 is generally C-shaped with forward extending lower and upper arms 56 and 57 that are joined vertically together by a central post section 58. Each of the upper and lower post arms 57 and 56 includes a free end 59 that projects forwardly of the central post section 58 and seats within the respective cups 47 and 26 on the upper and lower beams 37 and 22 (FIG. 3) such that each pair of the beams 37 and 22 and the associated post 54 swing as a unit about the vertical shoulder axis Sy.

As seen in FIG. 2, each post section 58 includes a bore 61 passing horizontally therethrough near the midpoint thereof. The post 54 is composed of a rigid material such as steel or aluminum.

Each post 54 further includes a second shoulder servo motor 62, identical to the motors 48, which motors 62 are secured to the central sections 58 of each post 54. Each motor 62 includes a drive shaft 63 which extends forwardly through the post bore 61. The forward end 64 of the shaft 63 includes a drive gear 66 (FIG. 5).

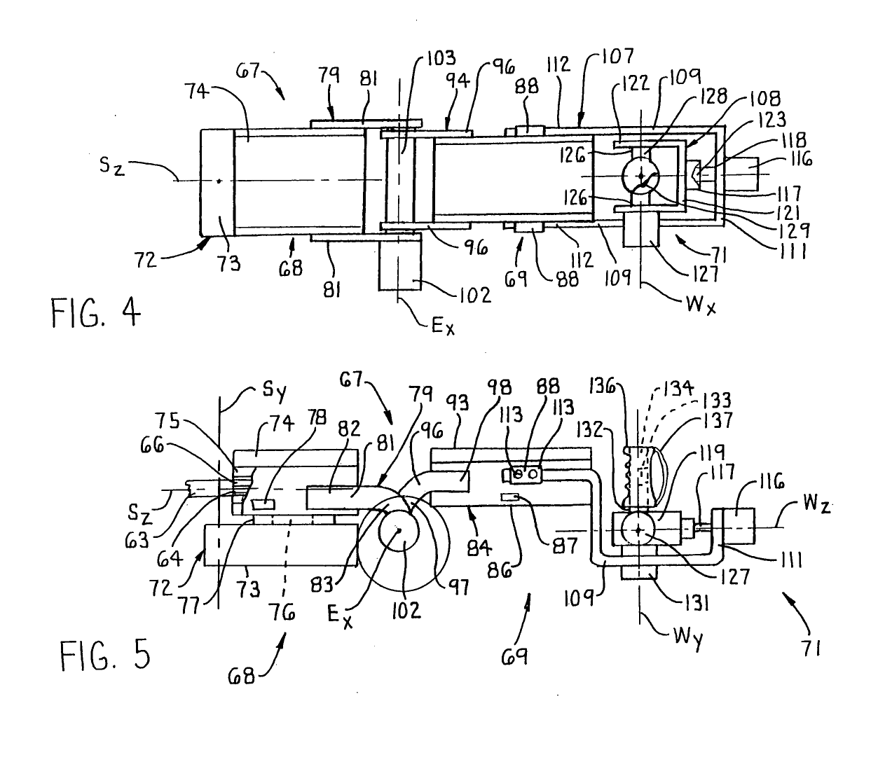

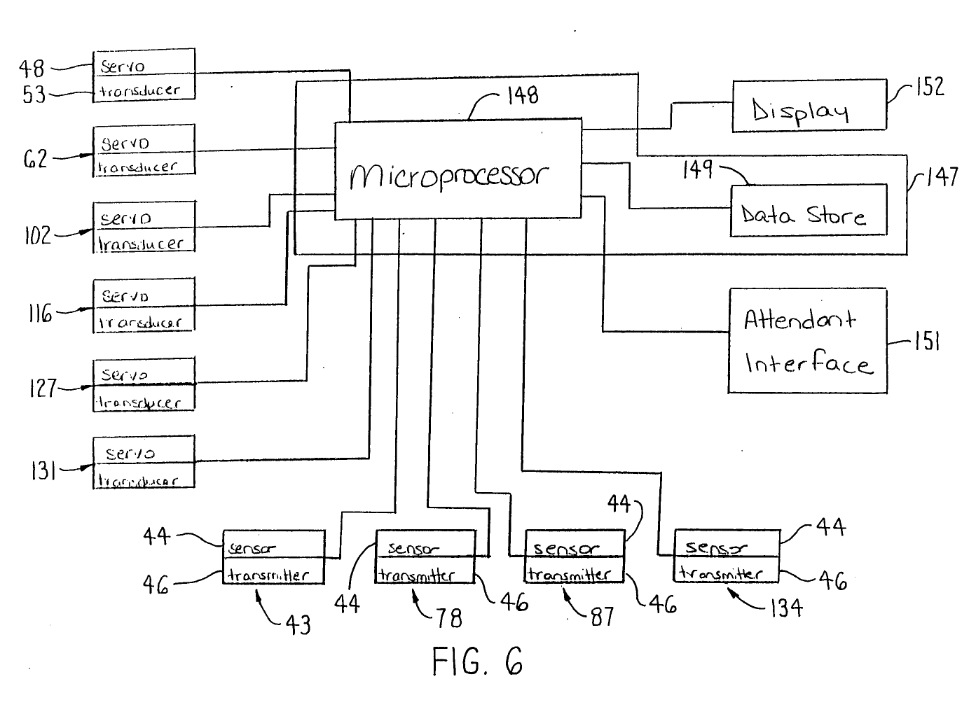

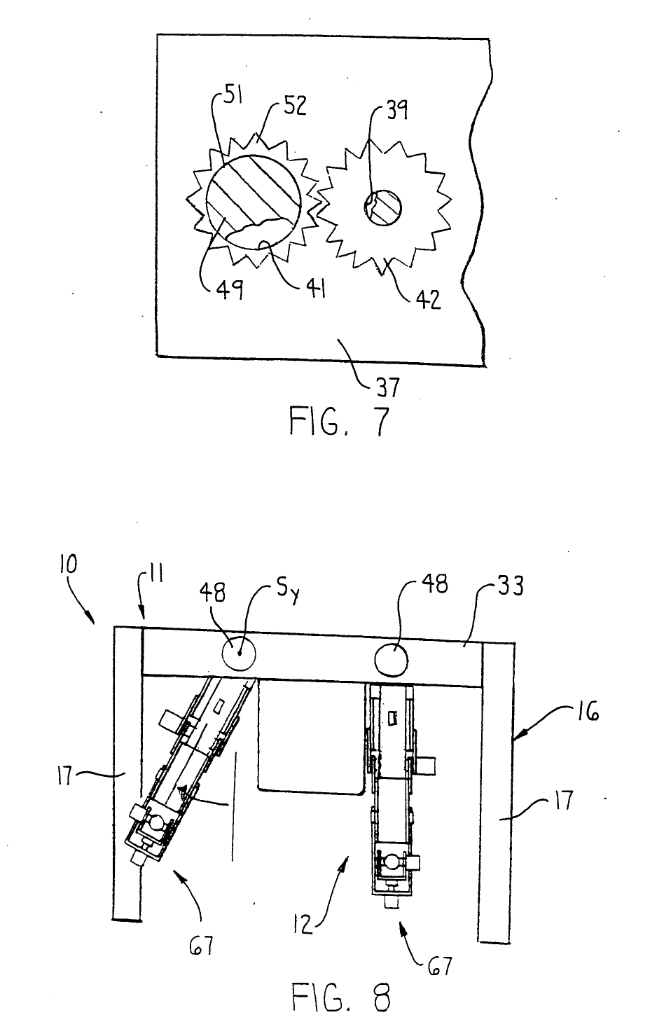

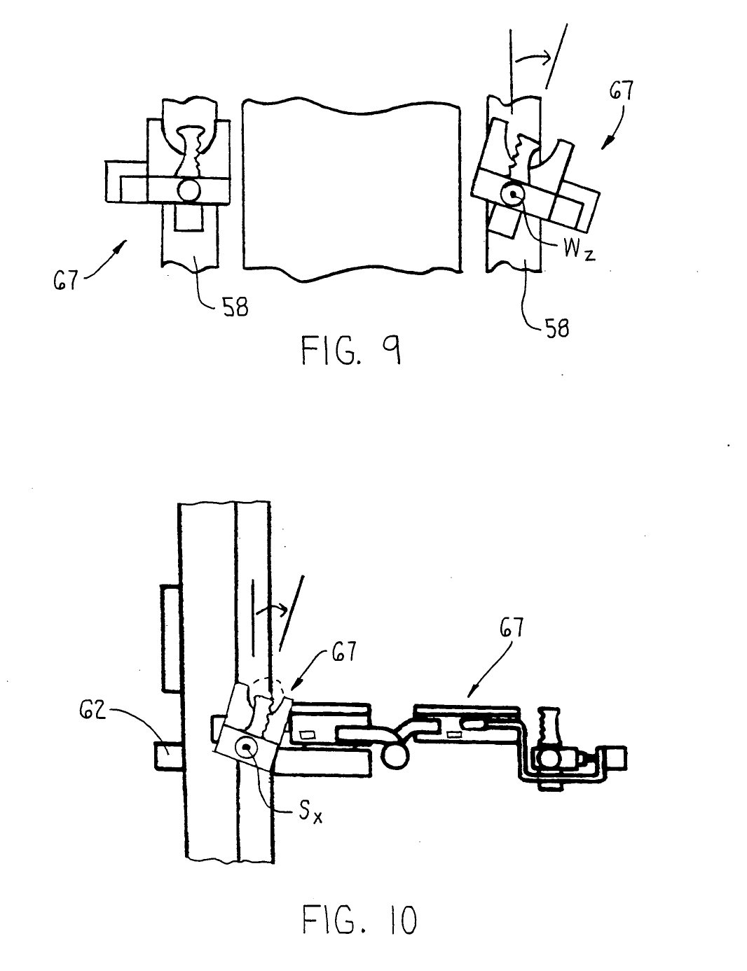

Referring to FIGS. 3, 4 and 5, the patient support assembly 12 further includes left and right arm support assemblies 67 which are mounted on the left and right posts 54 proximate the motor 62. The arm support assemblies 67 extend longitudinally away from the posts 54 and are adapted to support the individual arms of the patient to effect controlled articulation of the shoulder, elbow and wrist joints of the patient's arms. Each arm support assembly 67 includes an upper arm sub-assembly 68, a lower arm or forearm sub-assembly 69 and a hand or wrist sub-assembly 71 which are all connected in series one to the other. The left and right arm support assemblies 67 are substantially identical such that the following description is primarily directed to the right arm support assembly 67, it being understood that the following discussion applies equally to the left arm support assembly 67.

More particularly, the upper arm sub-assembly 68 includes an upper arm support unit 72 adapted to support the uppermost portion of the patient's arm located between the shoulder and elbow. The upper arm support 72 includes a rigid base 73 which is mounted on the post 54 and supports an upward-facing upper arm shelf 74. A pivot bracket 76 extends downward from the upper arm shelf 74 and is pivotally received by a complementary bracket 77 extending upwardly from the base 73. The upper arm shelf 74 includes a number of teeth 75 internally therein which are engaged with the gear 66 such that the upper arm shelf 74 is tiltable sidewardly by rotation of the gear 66 by the motor 62.

To monitor tilting of the arm shelf 74, a sensor assembly 78 is provided which sensor assembly 78 as seen in FIG. 6 comprises a sensor 44 and a transmitter 46 wherein the sensor assembly 78 is formed identical to the sensor assembly 43 described. As such, common reference numerals are used for the sensor and transmitter.

The sensor 44 is capable of detecting the distance the upper arm shelf 74 pivots or tilts with respect to the post 54 about the horizontal axis of the upper arm sub-assembly 68 which horizontal axis may align with either the second or the third shoulder axes Sz or Sx.

The upper arm shelf 74 is padded and preferably covered by a vinyl or fabric covering. Further the upper arm shelf 74 preferably is shaped so as to have a generally concave depression extending longitudinally therealong. The depression opens upwardly as illustrated in FIG. 1 to receive the upper portion of the patient's arm above the elbow.

The upper arm sub-assembly 68 further includes an upper arm connector frame 79. The connector frame 79 includes two arcuate bars or brackets 81 projecting forwardly therefrom. Each bar 81 is generally L-shaped and has first and second ends 82 and 83, wherein the forward end 83 curves downwardly with respect to the associated rearward end 82 as seen in FIG. 5. The forward bracket ends 82 generally are serially connected to and support the forearm sub-assembly 69 thereon.

More particularly, each forearm sub-assembly 69 includes a forearm support 84 having a rigid base 86. A sensor assembly 87 is attached to the base 86 wherein the sensor assembly 87 is identical to the sensor assembly 43 so as to include a sensor 44 and transmitter 46 (FIG. 6). The sensor 44 is capable of detecting the angular distance that the forearm support 84 pivots upwardly and downwardly with respect to the upper arm support 72 about a horizontal elbow axis Ex. To permit connection of the wrist sub-assembly 71 to the forearm sub-assembly 69, C-shaped brackets 88 are located on each side of the base 86.

A forearm shelf 93 is supported on the base 86, and as with the upper arm shelf 74, the lower arm shelf 93 is a padded, covered component having a generally concave depression when viewed longitudinally from the end to receive the forearm of the patient downwardly therein.

While the upper and lower arm shelves 74 and 93 are illustrated and described having concave or recessed cross sections, it should be appreciated that other configurations may be employed. However, the recessed shape of the shelves 74 and 93 illustrated herein are believed to provide greater patient comfort and support than shelves having alternate configurations. With the upright sides of the shelves 74 and 93, the shelves 74 and 93 are able to confine and control movement and rotation of the arm.

The forearm sub-assembly 69 also includes a connector frame 94 for connecting the forearm sub-assembly 69 to the above-described upper arm sub-assembly 68. The connector frame 94 includes two arcuate bars 96 having opposite first and second ends 97 and 98. The bars 96 are generally L-shaped with the first rearward end 97 of each bar 96 curving downwardly with respect to the associated forward second end 98, as illustrated in FIG. 5. The adjacent bar ends 83 and 97 are pivotally connected together such that the forearm sub-assembly 69 is pivotable upwardly from the horizontal position about the elbow axis Ex.

To effect such lifting of the forearm sub-assembly 69, an elbow servo motor 102 is mounted on the forward end 83 of the upper arm sub-assembly 68. The elbow motor 102 includes a shaft 103 which extends through the forward bar end 83 and the rearward bar end 97 to define a pivot connection between the adjacent bar ends 83 and 97. The motor 102 is identical to the motors 48 and 62 and drives the shaft 103 in opposite rotational directions to cause vertical pivoting of the forearm sub-assembly 69 about the elbow axis Ex.

The arm support assembly 67 further includes the wrist sub-assembly 71. Each wrist sub-assembly 71 includes a U-shaped outer frame 107 and a U-shaped inner frame 108 nested within the outer frame 107. The outer frame 107 has two spaced apart outer legs 109 which are separated by a transverse central section 111. Each outer leg 109 has a free end 112 which is affixed to the lower arm sub-assembly 69 by the mounting brackets 88 through fasteners 113.

A first wrist servo motor 116 is secured to the outer frame 107. The motor 116 includes a shaft 117 which extends horizontally through a bore in the transverse section 111 and supports the inner frame 108 thereon. The inner frame 108 has a U-shape defined by two inner legs 119 separated by an inner transverse section 121. Each inner leg 119 has a free end 122 that is spaced rearwardly of the inner transverse section 121. A rotation adjustment collar 123 is connected to the shaft 118 such that the inner frame 108 is rotatable by the motor 116 about the shaft axis.

Axially aligned bores 126 extend through the free ends of the inner legs 119 and a second wrist servo motor 127 is secured to the inner frame 108. The motor 127 includes a horizontal shaft 128 which extends horizontally through the bores 126. A bore 129 extends vertically through the shaft 128 near a mid-point thereof.

A third wrist servo motor 131 is suspended from the shaft 128. The third wrist servo motor 131 includes a vertical shaft 132 wherein an upper end 133 of the shaft 132 extends upward through the shaft bore 129.

A sensor assembly 134, which is identical to the sensor assemblies 43, 78, and 87, is attached to the shaft upper end 133. As illustrated in FIG. 6, the sensor assembly 134 includes a sensor 44 which is capable of detecting the distance the third servo motor shaft 132 pivots with respect to the second servo motor shaft 63, the inner frame 108 and the outer frame 107 about a first wrist axis Wx, a second wrist axis Wy and a third wrist axis Wz.

A grip or handle 136 is fitted over the upper end 133 of the shaft 132. The handle 136 is configured to allow a patient to comfortably grip the shaft 132. For instance, the handle 136 may include one or more grooves, such as those illustrated herein, to receive the fingers of a patient. An adjustable strap 137 extends between upper and lower ends of the handle 136.

Returning to FIGS. 1-3, the patient support assembly 12 is attached to the central column 27 of the frame assembly 11. As illustrated, the patient support assembly 12 includes a back 138 and a seat 139. The back 138 is a conventional backrest, such as those incorporated into traditional weight and/or exercise machines. The back 138 preferably includes a rigid base having a padded front or patient contact surface 141.

The patient support seat 139 preferably includes an upper padded portion 142 supported on a rigid base 143. Extending downward from the base 143 is a brace 144 having a free end 146 which slidably engages the adjustment slot 32 such that the height of the seat 139 is vertically adjustable.

Referring now to FIG. 3, the control system 13 of the present invention includes a control unit 147. As schematically illustrated in FIG. 6, the control unit 147 has a microprocessor 148 and a data store 149. An attendant interface 151 is connected to the control unit 147. The attendant interface 151 is preferably a touch screen interface, however, alternative interfaces, such as a keyboard, may be substituted. Also connected to the control unit is a display screen 152.

### ASSEMBLY OF FIRST EMBODIMENT

To assemble the exercise therapy device 10, the stationary post support components 21 and the central column 27 are welded to the base 16. Alternatively, these components may be secured to the base 16 by another suitable method, such as one or more bolts. The upper frame element 33 is welded to the column 27, or otherwise fixedly secured thereto. Each stationary post suspension component 36 is secured to the underside of the upper frame element 33, such as by welding, as illustrated, or in another suitable manner.

Each lower support arm 22 is positioned over the associated stationary frame support component 21 so the respective bores are aligned. Bolts (not shown) are inserted through the bores to pivotally secure each lower support arm 22 to the associated stationary component 21. Similarly, each upper arm 37 is positioned adjacent the respective stationary frame suspension component 36 and secured thereto by bolts, not shown.

The left and right posts 54 are secured to the base 16 and the upper element 33. The free end 59 of each post lower arm 56 is inserted into the sleeve 26 of each rotatable post support component 22. The sleeve bore and the lower post arm bore are aligned and a bolt, pin or other suitable device is inserted therethrough to secure these components together. Similarly, the free end 59 of each upper post arm 57 is inserted into the sleeve 47 of each rotatable post suspension component 37 and secured thereto by a bolt or pin. Alternatively, the posts 54 could be secured to the respective rotatable members 22 and 37 by welding the upper and lower post arm free ends 59 to the associated sleeve 26 or 47. In this alternative, the sleeves 26 and 47 and the upper and lower post arms 27 and 26 omit the associated bores.

The patient support back 138 is non-movably secured to the column 27 in a suitable manner, such as by one or more bolts. Alternatively, if the back 138 has a suitable, rigid base, the back 138 may be welded to the central column 27.

The patient support seat 139 is secured to the central column 27. The seat 139 is positioned adjacent the central column 27 so the brace free end 146 extends into the central column lower slot 32. The seat 139 is secured to the central column 27 in any conventional manner which allows the seat 139 to be adjustable between a range of heights. A particular attachment means is not required by the present invention and therefore, any conventional means may be used. For instance, a spring biased pin may extend into one of the column side surfaces 31. The pin may engage one of a series of bores in the brace free end 146 to lock the seat 139 in the desired position.

Returning to the frame assembly 11, each first shoulder servo motor 48 is positioned atop the associated end of the upper frame element 33. Each servo motor 48 is positioned so the respective shaft 49 extends downward into the bore 41 of the associated rotatable post suspension member 37. When the shaft 49 of each servo motor 48 is appropriately positioned, each gear ring 52 will engage the associated rotatable member adjustment ring 42. The sensor assembly 43 is secured to the rotatable component 37 with an adhesive or other suitable fastener.

Each second shoulder servo motor 62 is positioned adjacent the associated post 54 so the servo motor shaft 63 extends through the respective post central section bore 61. Each servo motor 62 may be secured to the respective post 54 by a bracket or other suitable support.

The left and right arm assemblies 67 are next constructed. Since each arm assembly 67 is constructed in an identical manner, assembly of only the left arm assembly 67 will be described in detail.

The left upper arm sub-assembly 68 is constructed by securing the upper arm shelf 74 to the upper arm support base 73, so the upper arm shelf track 76 is locked into the upper arm support base track 77. The first end 82 of each bar 81 is attached to the base 73 by a bolt or other suitable fastener. The sensor assembly 78 is secured to the upper arm shelf 74 by an adhesive or other suitable fastener.

The lower arm sub-assembly 69 is constructed by securing the lower arm shelf 93 to the base 86. The sensor assembly 87 is secured to the lower arm base 86 by an adhesive or other suitable fastener. The bar second ends 98 are secured to either side of the lower arm support base 86. As with the upper arm support sub-assembly 68, the bars 96 may be secured to the lower arm support 84 either by bolts inserted through the bar second end 98 bores or by welding.

The upper support frame 79 bar second ends 83 are positioned adjacent the lower support frame 94 bar second ends 98 so the bores are axially aligned and the upper frame bars 81 are positioned adjacent outer surfaces of the lower frame bars 96. The elbow servo motor 102 is positioned adjacent each set of upper and lower bars 81 and 96. The servo motor shaft free end 104 is inserted through the bores 99. The servo motor 102 may be secured to the upper support frame bar 81 by a bracket, strap or other suitable device.

Construction of the arm support assembly 67 is completed by assembly and attachment of the hand support sub-assembly 71. The second wrist servo motor shaft 128 is inserted through the bores 126 of the inner frame segments 119. The second wrist servo motor 127 may be secured to the inner frame 108, if desired. The third wrist servo motor shaft 132 is inserted through the bore 129 in the shaft 128. The sensor assembly 134 is secured thereto, such as by a suitable adhesive. The hand grip 136 is fitted around the upper end 133 of the shaft 132.

The inner frame 108 is positioned within the perimeter of the outer frame 107. The first wrist servo motor shaft 117 is inserted through the outer frame central bore 114 and into the inner frame central bore 123. The shaft free end is fixedly secured in the inner frame member bore 123 so the shaft 117 is incapable of pivoting with respect to the central inner frame central section 121. The servo motor 116 may be secured to the outer frame central member 111 in a suitable manner.

The first end 112 of each outer segment 109 is inserted in the respective bracket 88 extending from the lower arm support base 86. The outer segments 109 are positioned in the brackets 88 so the outer segment bores 113 are aligned with the respective bracket bores 92. Bolts or other suitable fasteners are inserted through the bores to secure the outer arms 109, and thus the hand support sub-assembly 71 to the lower arm support sub-assembly 69.

Each constructed arm support assembly 67 is secured to the respective post 54. The upper arm support base 73 is positioned adjacent the associated post 54 just below the post central bore 61. The upper arm support base 73 is secured to the respective post 54 in a suitable manner, such as by bolt or another suitable fastener. The second servo motor shaft 63 is then inserted through the post central bore 61 and into the upper arm shelf 74 so the gear ring 66 engages the teeth 75.

If desired, the control system 13 is connected to the remainder of the exercise therapy device 10. For instance, it might be desirable to secure the control unit 147 and attendant interface 151 to the frame central column 27. Alternatively, an attendant might prefer to have the controls located at a separate location, such as a central control bank including the control units 147 for several exercise therapy devices 10.

### OPERATION OF FIRST EMBODIMENT

To use the exercise therapy device 10 of the first embodiment, the patient support seat 139 is adjusted to the desired vertical position for the patient. The patient is seated on the patient support seat 139. If desired, the patient may be secured to the seat portion thereof by a waist belt or strap.

Once the patient is appropriately seated, one or both of the patient's arms are positioned in the associated arm support assemblies 67. As each arm is secured to the respective arm support assembly 67 in an identical manner, the positioning of only one arm will be described.

The patient's arm is positioned over the associated arm support assembly 67 so the patient's upper and lower arms are received in the respective upper and lower arm shelves 74 and 93. The patient's arm may be secured to the upper and/or lower arm shelves 74 and 93, such as by straps, if desired. The patient's hand is wrapped around the handle 136 and secured thereto by the strap 137 (FIG. 5).

Once the patient is secured to the therapy device 10, the attendant programs the control unit 147 to begin the appropriate therapy sequence in the desired operational mode. At least six operational modes are contemplated by the present invention. The appropriate operational mode will be determined based on the current treatment needs of the patient. Each treatment mode will involve movement of at least one of the patient's arms about one or more of the shoulder, elbow and wrist axes Sx, Sy, Sz, Ey, Wx, Wy and Wz. Movement of the patient's arm about each of these axes will be described below.

To move the patient's left arm about the vertical first shoulder axis Sy, the microprocessor 148 generates an appropriate energization signal. The energization signal is transmitted to the transducer in the first shoulder servo motor 48. Based on this energization signal, the transducer actuates the servo motor 48. When the servo motor 48 is actuated, the shaft 49 is rotated about the vertical axis Sy. The gear ring 52 on the shaft end 51 engages the adjustment ring 42 secured adjacent the rotatable suspension component bore 41 to rotate the rotatable component 37 about the axis Sy with respect to the stationary component 36. Rotation of the rotatable component 37 about the axis Sy results in a corresponding rotation of the associated post 54 and arm support assembly 67, and thus the patient's arm, about the axis Sy to the position illustrated in FIG. 8.

The microprocessor 148 generates control signals which are transmitted to the transducer representative of the angular distance the patient's arm is to be pivoted outwardly and inwardly about the axis Sy and the number of times the arm is to pivot about the axis Sy. Once the arm is rotated about the axis Sy the desired number of times, the microprocessor 148 transmits a control signal to the transducer to return the rotatable member 37 to the rest position. If the patient's treatment is completed, or if the patient's arm will not be rotated about the axis Sy for the remainder of the treatment session, the control signal may include a command to de-activate the first shoulder servo motor 48.

Movement of the patient's left arm about the longitudinal second shoulder axis Sz is initiated by an energization signal which is generated by the microprocessor 148. The energization signal is transmitted to the second shoulder servo motor 62 transducer, which actuates the servo motor 62. The servo motor shaft 63 is rotated about the axis Sz. The gear ring 66 on the shaft 63 drives the teeth 75 on the upper arm support shelf 74 to rotate the left arm support assembly 67 about the axis Sz. Rotation of the left arm support assembly 67 about the axis Sz results in a corresponding rotation of the patient's left arm about the axis Sz to the position illustrated in FIG. 9.

The microprocessor 148 generates and transmits to the transducer continuous control signals representative of the angular distance the patient's left arm is to be pivoted about the axis Sz through a limited angular distance and the number of times the patient's left arm is to be rotated back and forth about the axis Sy. Once the patient's left arm is partially rotated about the axis Sz the desired number of times, the microprocessor 148 generates a new control signal. This control signal is transmitted to the transducer. In response, the transducer instructs the servo motor 62 to return the arm support assembly 67 to the rest position. If the patient's treatment is completed, or if the patient's left arm will not be rotated about the axis Sz for the remainder of the treatment session, the control signal may include a command to de-activate the second shoulder servo motor 62.

Referring now to FIG. 10, to move the patient's right arm about the third shoulder axis Sx, the microprocessor 148 generates a first energization signal which is transmitted to the transducer in the first shoulder servo motor 48. The transducer actuates the servo motor 48 in response to the received energization signal. The servo motor shaft 49 is rotated 90 degrees about the vertical axis Sy. As the shaft 49 rotates, the drive gear ring 52 drives or rotates the driven gear 42 and results in rotation of the post 54 and the right arm support assembly 67, and thus the patient's right arm, 90 degrees about the axis Sy so that the arm extends straight to the side as seen in FIG. 10 along the transverse axis Sx.

The microprocessor 148 then generates a second energization signal which is transmitted to the transducer in the second shoulder servo motor 62. The second shoulder servo motor 62 is actuated and the associated shaft 63 is rotated with respect to the horizontal axis Sx which thereby rotates the arm through a limited angular distance. The shaft gear 66 interacts with the upper arm support shelf teeth 75 to rotate the right arm support assembly 67 about the axis Sx with respect to the right post 54. Rotation of the arm support assembly 67 about the axis Sx results in a corresponding rotation of the patient's right arm through an angular distance about the axis Sx to the position illustrated in FIG. 10.

The microprocessor 148 transmits continuous control signals to the second shoulder servo motor transducer. These signals represent the angular distance the patient's right arm is to be pivoted about the axis Sx and the number of times the arm is to be pivoted. Once the patient's right arm is rotated about the axis Sx the desired number of times, the microprocessor 148 generates a new control signal. This control signal is transmitted to the second shoulder servo motor transducer. In response to this new received control signal, the transducer instructs the servo motor 62 to return the arm right support assembly 67 to the rest position. The microprocessor 148 then generates a control signal which is transmitted to the first shoulder servo motor transducer to likewise return the patient's right arm to the rest position with respect to the axis Sz. If the patient's treatment is completed, or if the patient's arm will not be rotated about either of the axes for the remainder of the treatment session, one or both of the control signals may include a command to de-activate the first and/or second shoulder servo motors 48 and 62.

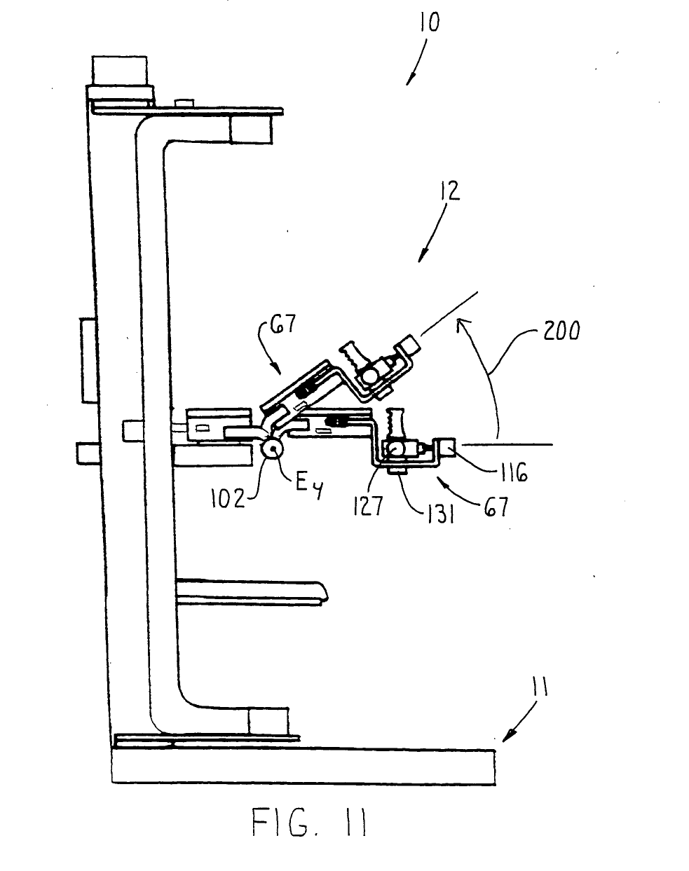

To move the patient's left lower arm with respect to the left upper arm about the transverse elbow axis Ex, the microprocessor 148 generates an energization signal which is transmitted to the transducer in the elbow servo motor 102. The transducer actuates the servo motor 102 in response to the received energization signal, causing the servo motor shaft 103 to rotate about the axis Ex. Since the shaft 103 diameter is smaller than the diameter of the upper arm frame bar 81 bores, this rotation does not cause movement of the upper arm support base 73. Rotation of the shaft 103 results in a corresponding pivoting of the lower frame bars 96 about the axis Ex. Rotation of the lower frame bars 96 results in a corresponding rotation of the patient's right lower arm about the axis Ex with respect to the right upper arm to the position illustrated in FIG. 11.

Continuous control signals are transmitted by the microprocessor 148 representing the angular distance 200 (FIG. 11) and the number of rotations of the right lower arm with respect to the right upper arm. Once the patient's right lower arm is rotated about the axis Ex the desired number of times, the microprocessor 148 generates a new control signal and transmits this control signal to the transducer. The transducer instructs the servo motor 102 to return the right arm support assembly 67 to the rest position. If the patient's treatment is completed, or if the patient's arm will not be rotated about the axis Ex for the remainder of the treatment session, the control signal may include a command to de-activate the servo motor 102.

Movement of the patient's-hand with respect to the associated lower arm about any of the wrist axes Wx, Wy and Wz as illustrated in FIGS. 12, 13 and 14, is initiated by an energization signal generated by the microprocessor 148. This energization signal is transmitted to the transducer in the appropriate wrist servo motor 116, 127 and 131.

Where movement of the patient's left hand about the vertical wrist axis Wy is desired, as illustrated in FIG. 14, the energization signal is transmitted to the transducer in the third wrist servo motor 131. In this instance, the transducer actuates the servo motor 131, causing the servo motor shaft 132, and therefore the handle 136, to rotate about the vertical axis Wy through an angular distance identified by reference arrow 201. The patient's left hand, which is secured to the handle 136, is rotated about the axis in a corresponding manner, as illustrated in FIG. 14.

When movement of the right hand about the transverse second wrist axis Wx is desired, as illustrated in FIG. 12, the energization signal is transmitted to the transducer in the second wrist servo motor 127. The transducer actuates the servo motor 127, causing the shaft 128 to rotate about the axis Wx. Rotation of the shaft 128 causes a corresponding rotation of the handle 136, and thus the patient's hand, about the axis Wx.

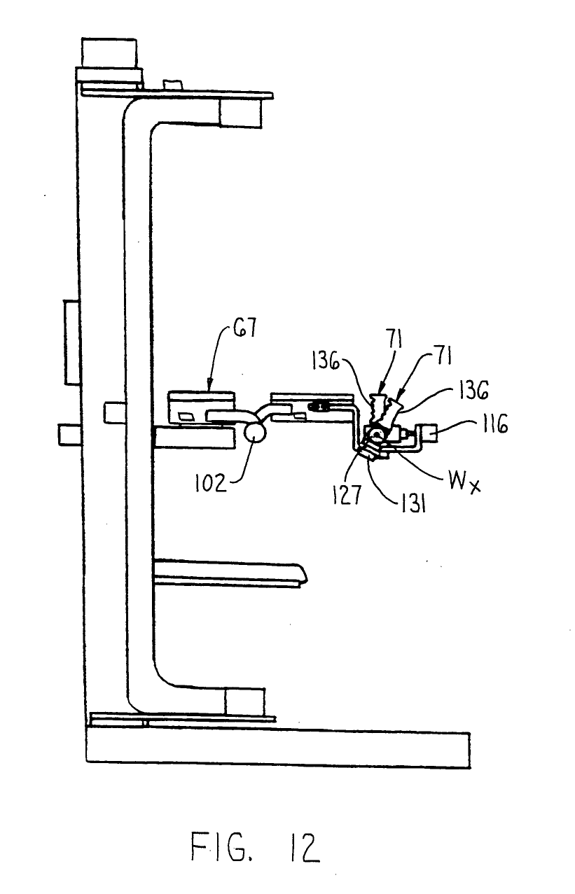

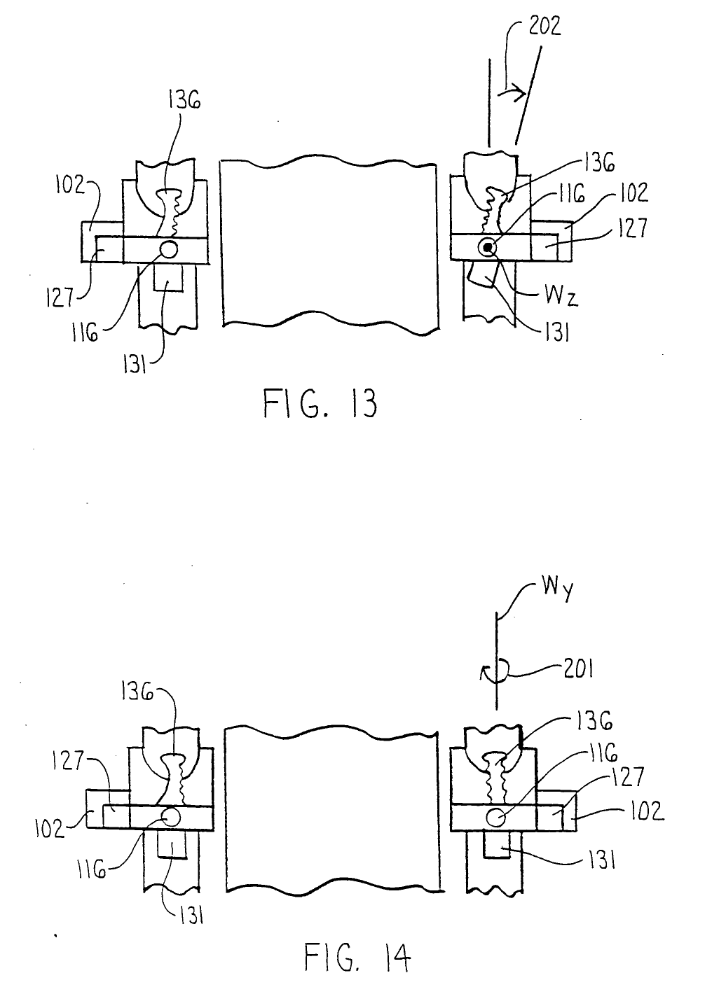

Finally, when movement of the patient's left hand about the longitudinal third wrist axis Wz is desired, as illustrated in FIG. 13, the energization signal is transmitted to the transducer in the first wrist servo motor 116. The servo motor 116 is actuated by the transducer to rotate the shaft 117 about the axis Wz. As the shaft 117 rotates, the inner frame 108 and the handle 136 rotate a limited angular distance identified by reference arrow 202. This rotation of the handle 136 results in rotation of the patient's hand about the axis Wz.

Continuous control signals are transmitted by the microprocessor 148 to the appropriate transducer for continued movement. These control signals represent the angular distance the hand is to be pivoted about the relevant axis Wx, Wy or Wz and the number of times the hand is to be pivoted about that axis. Once the patient's hand is rotated about the relevant axis the desired number of times, the microprocessor 148 generates a new control signal. This control signal is transmitted to the appropriate transducer and instructs the transducer to control the servo motor 116, 127 or 131 to return the handle 136 to the rest position. If the patient's treatment is completed, or if the patient's hand will not be rotated about the axis for the remainder of the treatment session, the control signal may include a command to de-activate the corresponding servo motor 116, 127 or 131.

As indicated previously, the exercise therapy device 10 may be operated in one of six primary operational modes to treat a patient. For purposes of the description of these operational modes, the fully mobile patient arm will be referred to as the healthy arm. The arm affected by the stroke or other injury will be referred to as the stricken arm.

The first operational mode contemplated herein is the “mirrored motion mode”. Typically, stroke victims suffer loss of controlled motion on only one side of their body. In this mode of operation, both of the patient's arms are secured respectively to the left and right arm support assemblies 67. For purposes of this illustration only, the patient has a healthy left arm and a stricken right arm.

The patient moves his healthy left arm through a series of motions, including movements through some or all of the seven axes of motion, described above. These movements may be according to a treatment routine directed by treatment personnel or the movements may be relatively random according to pattern determined by the patient. As the patient moves the healthy arm, the appropriate sensors positioned on the respective left frame members register both the direction and amount of movement of the respective left arm joint.

For instance, if the patient moves his left hand clockwise 45 degrees about the first wrist axis Wy, the wrist sensor 44 of the sensor 134 detects the movement and generates a detection signal indicative of this movement information. This detection signal is transmitted to the microprocessor 148 by the transmitter 46 of the sensor assembly 134. The microprocessor 148 receives the detection signal, processes the signal and generates a corresponding command signal. The command signal is transmitted to the wrist servo motor 131 secured to the right arm support assembly 67. The right servo motor 131 is actuated by this command signal and moves the patient's right hand clockwise 45 degrees about the first wrist axis Wy. For each movement that the patient makes with his or her healthy left arm, the stricken right arm is moved to mirror in a manner similar to that described above.

This procedure of detecting motion of the healthy arm and mirroring this motion in the stricken arm may occur for arm movement about any axis.

The second operational mode is the single or multiple axis “repetitive motion mode”. In this operational mode, a single joint is exercised while the remaining joints are held stationary. For instance, if the patient's left wrist is stricken, the treating attendant may choose to move the left wrist with respect to one, two or all three of the wrist axes. The attendant enters the following information at the interface: the wrist to be exercised, the axes about which the wrist will be exercised, the angular range of motion through which the wrist will be moved, the speed at which the wrist will be moved and the number of repetitions. The microprocessor 148 then generates one or more control signals based on the input information. The control signals are transferred to the appropriate left wrist servo motor or motors. Each appropriate servo motors is actuated in the manner described above to move the left wrist about the relevant axis, as instructed.

The third operational mode is the single axis “parallel motion mode”. This mode of operation is similar to the single axis repetitive motion mode. However, in this operational mode, both of the patient's arms are moved in mirrored relation. Thus, if the attendant determines that the patient's treatment should focus on the elbow, the following information is entered: both elbows in parallel motion, movement of the lower arms with respect to the upper arms about the elbows, the range of motion through which the lower arms will be moved about the elbow, speed of movement and the number of repetitions. The microprocessor 148 then generates the appropriate control signals to activate the elbow servo motors 102 for the programmed treatment.

The fourth operational mode is the “coordinated series motion mode”. In this operational mode, the patient's stricken arm is repeatedly moved through a series of moves about one or more of the axes. Thus, if the patient has a stricken left arm, that limb will be moved through a series of movements about some or all of the axes. For example, the left arm could be guided through a series of movements in which the shoulder, elbow and wrist are moved sequentially about each of the seven axes. For operation in this mode, the attendant either manually inputs the series of movements for the left arm to be moved through or selects from one of a number of stored programs. The microprocessor 148 then activates, controls, and deactivates the appropriate servo motors to move the stricken arm according to the desired treatment program.

The fifth operational mode is the “series parallel motion mode”. This mode of operation is similar to the coordinated series motion mode. However, in this mode of operation, both arms are guided through the series of moves based on either input from the attendant or a stored exercise program.

The sixth operational mode is the “strength measurement motion mode”. In this mode of operation, the strength of one or both of the patient's arms is measured and recorded. In this mode of operation, the patient moves one arm about one or more of the axes at the direction of the attendant. This mode of operation could be useful to measure the progress of a stroke victim who is regaining the use of a stricken right arm. In this operational mode, the sensors 44 detect the distance one or more of the hand, lower arm and/or upper arm move about the associated wrist, elbow and shoulder axes. For instance, if the patient moves his right lower arm about the elbow axis Ey 20 degrees, the lower arm sensor 44 detects the movement and generates a detection signal indicative of this information. The detection signal is transmitted to the microprocessor 148 by the transmitter 46. The microprocessor 148 receives the detection signal and generates a strength data signal which is transmitted to the attendant interface 151. In addition, this strength data signal may also be transmitted to the control unit data store 148 so information relating to the patient's progress is maintained within the control unit. Each movement by the patient is similarly detected by the appropriate sensor 44, which transmits information to the microprocessor 148 for use by the attendant.

In addition to the above, treatment in this operational mode may include introduction of resistance to patient movement. Once the patient has recovered beyond a predetermined threshold, the patient may be asked to work against the device to move a recovering arm to a particular orientation. For instance, if the attendant wants to evaluate the strength of the patient's right wrist, he or she inputs a direction for the exercise therapy device 10 to move the patient's hand counterclockwise 45 degrees about the first wrist axis Wy. The microprocessor 148 then generates a signal instructing the third servo motor 131 to rotate the shaft 132, and therefore the handle 136, 45 degrees about the first wrist axis Wy in the counterclockwise direction and to maintain that position. The patient is then instructed to attempt to return the handle 136 to the rest position, or to rotate the handle 136 beyond the rest position in the clockwise direction. The wrist sensor 44 detects any movement of the handle 136, and therefore the patient's hand, in the clockwise direction about the first wrist axis Wy and generates a detection signal indicative of this movement information, which signal is transmitted to the microprocessor 148. The microprocessor 148 generates a resistance data signal that is transmitted to the attendant interface 151 and, if desired, to the control unit data store 149. This procedure may be repeated for the hand about the same axis or about one or both of the remaining axes. Similarly, this procedure may be repeated for the patient's lower and upper arms.

### MODIFICATIONS

It will be understood that while the servo motors and associated sensors are illustrated as separate components, it is preferred that servo motors be used with the appropriate sensor components incorporated therein. Such servo motors are known and further disclosure thereof is not required.

In a further embodiment, the arm assemblies 67 may be pivotally connected to the posts 54 so as to be pivotable up and down with respect to front of frame about axis Sx when the arm assemblies 67 are in the position of FIG. 1. The arm assembly 67 would include a further motor at the pivot connection to pivot the arm assemblies 67 upwardly about Sx in a manner similar to the raising and lowering of the forearm sub-assemblies 69 about elbow axis Ex. With this arrangement, the motor 62 would be mounted on and move with the arm assembly 67; rotation about Sx by second servo motor and about Sy by combo of first plus second servo motor.

In addition to the above, it should be appreciated that additional modifications are contemplated by the present invention. While the exercise therapy device 10 disclosed herein has been primarily disclosed with respect to treatment of stroke patients, there are numerous contemplated uses for such a device. For instance, the exercise therapy device 10 could be used in at least any of the six disclosed operational modes for rehabilitation of patient injuries stemming from work, auto or other related accidents. In addition, the exercise therapy device 10 could be used for athletic training, training regimens or measuring the progress of an athlete or other person's fitness, particularly in the strength measurement motion mode.

In addition to the above modifications, it should be appreciated that the present therapy device could be modified for rehabilitation of a patient's leg. Such a device could provide left and right leg supports which allow for movement of the associated leg about the hip, knee and ankle axes of rotation. For instance, such a modification could provide a support harness, rather than the seat illustrated herein, from which extend two leg supports which are configured similar to the arm supports. The harness and leg support assembly could be suspended over a treadmill. A patient would then be positioned in the harness with his or her legs secured in the leg supports. Depending on the desired treatment regiment, one or both of the patient's legs could be moved by the leg supports to simulate walking so the patient could walk on the treadmill.

Further to the above modifications, the exercise therapy device 10 described herein could be modified in a variety of manners without departing from the spirit of the claims. For instance, the preferred touch screen attendant interface 151 could be replaced with a keyboard or a voice recognition/response interface. The patient support assembly could be modified so the seat 139 extends further outward to support a patient's outstretched legs. Further, the seat 139 could be easily removable to allow a patient in an alternative support, such as a hospital cot, to be pulled flush with the central column 27 of the frame assembly 11. In addition, rather than entry of a particular routine during each treatment session, the attendant could call up a program which was designed for the particular patient. This program could include a single routine, such as a special routine ordered by a physician, or an entire treatment regiment so that the appropriate treatment for the particular day/session number is performed. This program could be stored in the control unit data store 149 or on a readable medium such as CD or disk.

Second Embodiment

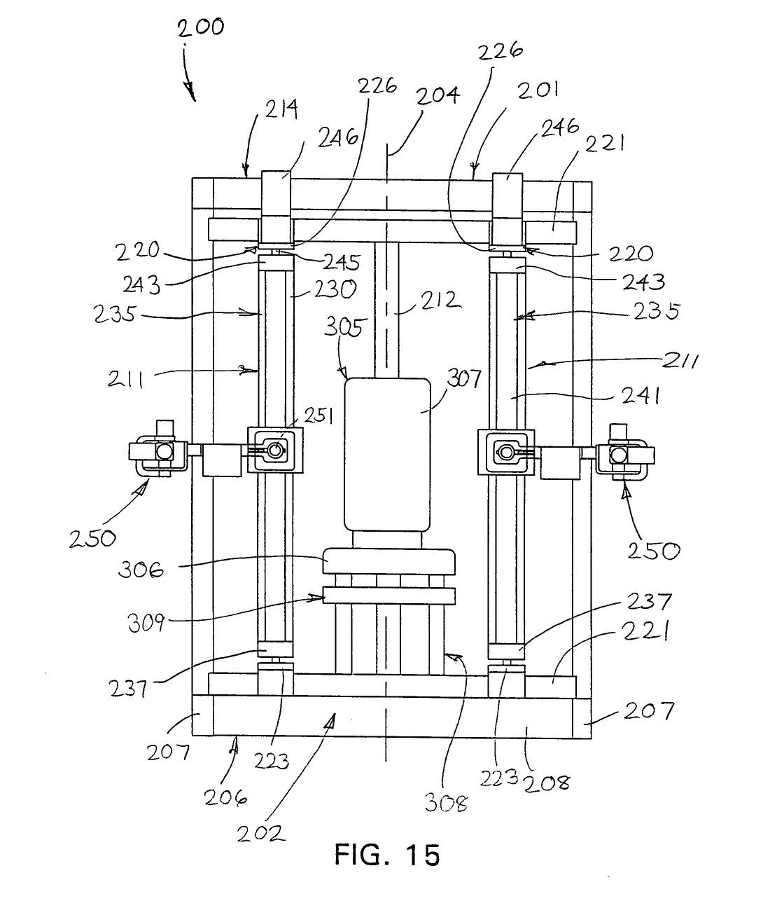

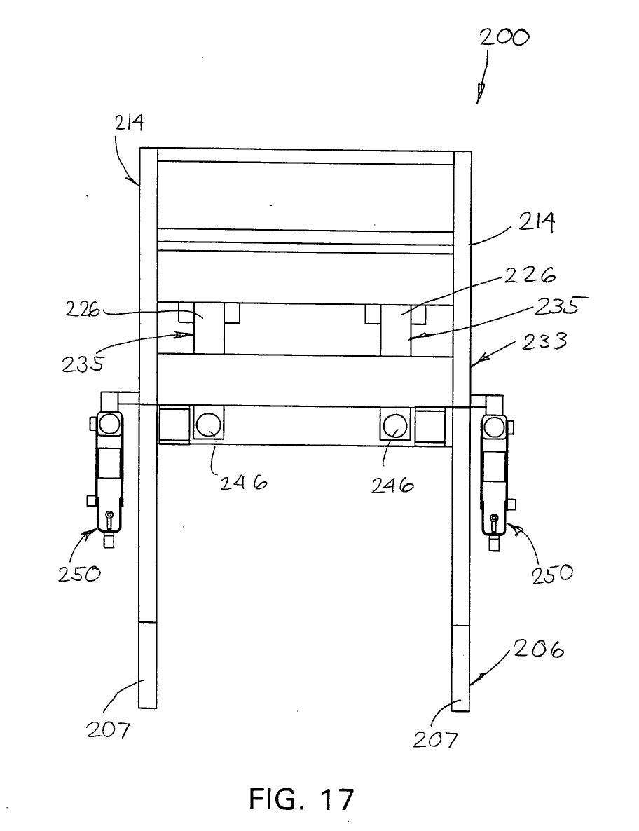

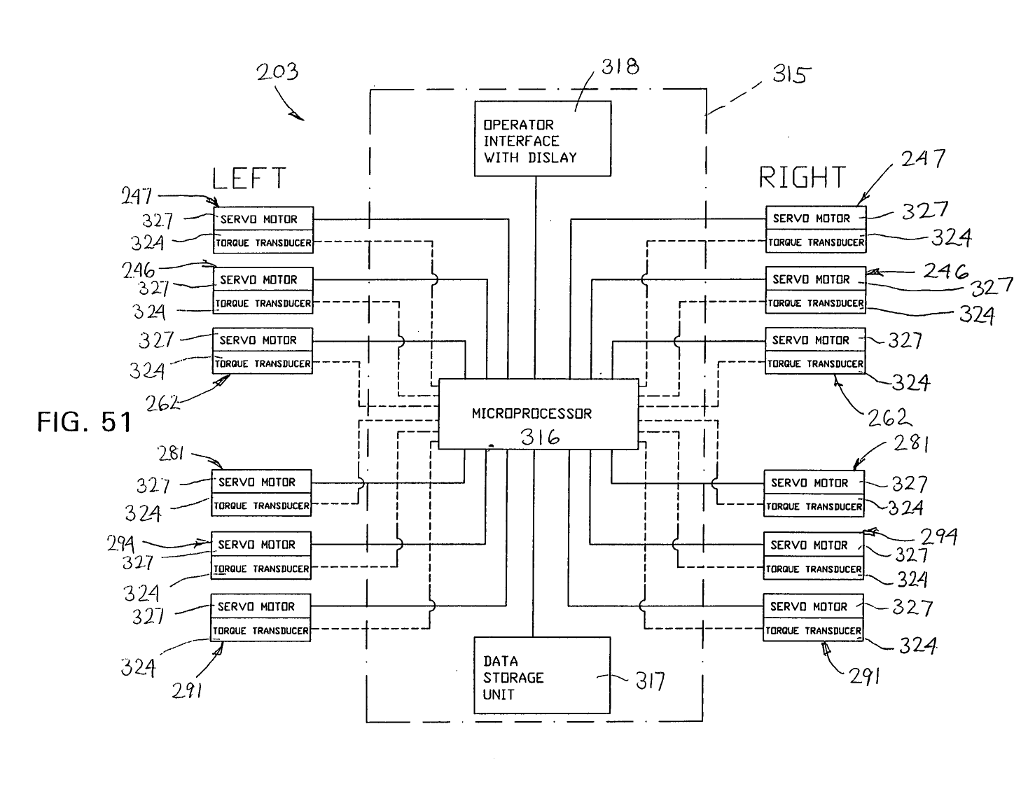

Referring to FIGS. 15-17, there is illustrated a second improved embodiment of an exercise therapy device 200 according to the present invention. The exercise therapy device 200 includes a frame 201, a patient support assembly 202 mounted on the frame, and a control system 203 (FIG. 51). As discussed herein, the exercise therapy device 200 is symmetrical about a central vertical axis to permit movement and rehabilitation of both left and right sides of the patient.

The frame 201 includes a generally U-shaped base 206 having first and second arms 207 which are connected sidewardly together by a central frame section 208. The base 206 is formed of a suitable rigid material, such as aluminum or steel.

To support the patient arm support assembly 202, the frame 201 includes a series of vertical columns 210, 211, 212 extending upwardly from the base section 207 wherein column 212 is a seat-supporting column located centrally on the base 206.

A generally rectangular upper frame element 214 is supported on the upper ends of vertical columns 210, 211, 212 so as to extend across the transverse width of the therapy device 200. The upper frame element 214 is formed of a rigid material and secured to columns 210, 211, 212 is a suitable manner, such as welding.

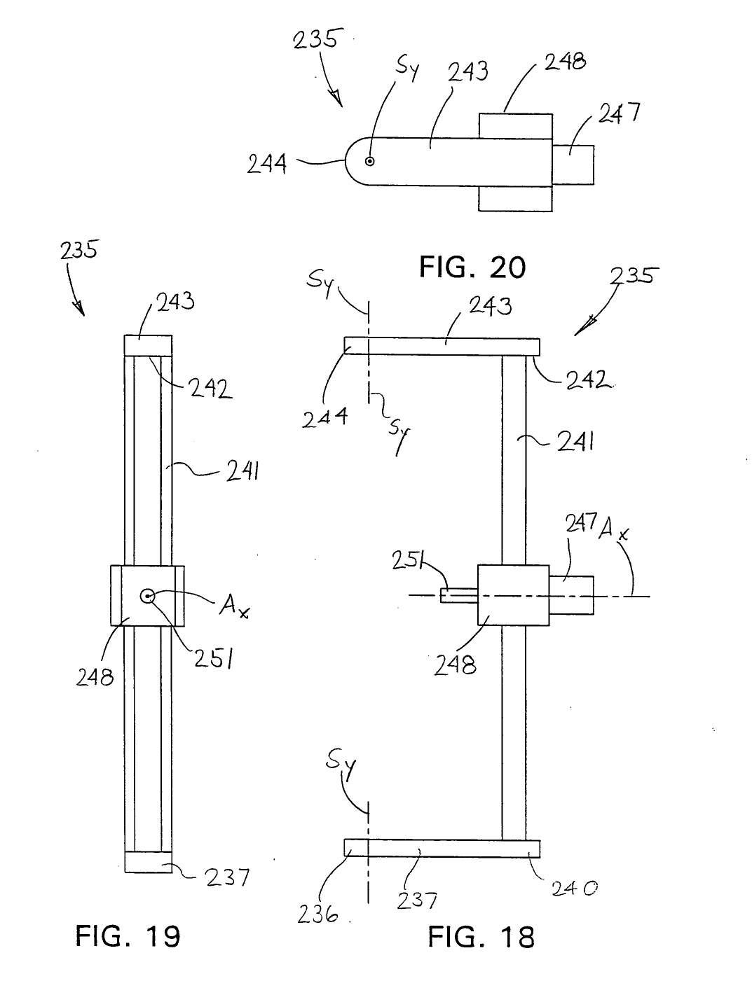

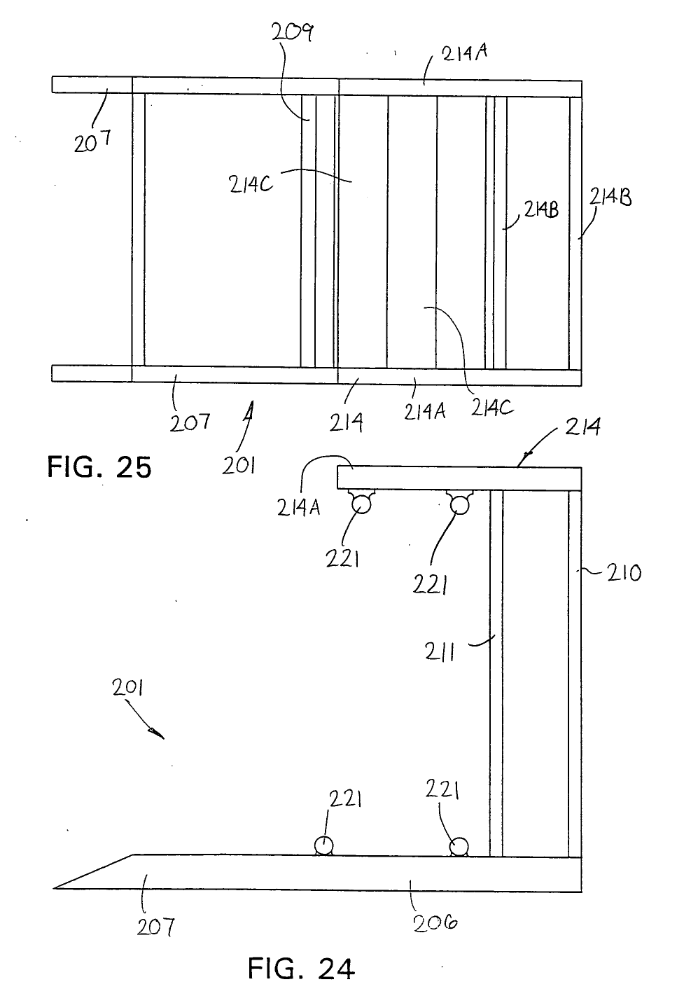

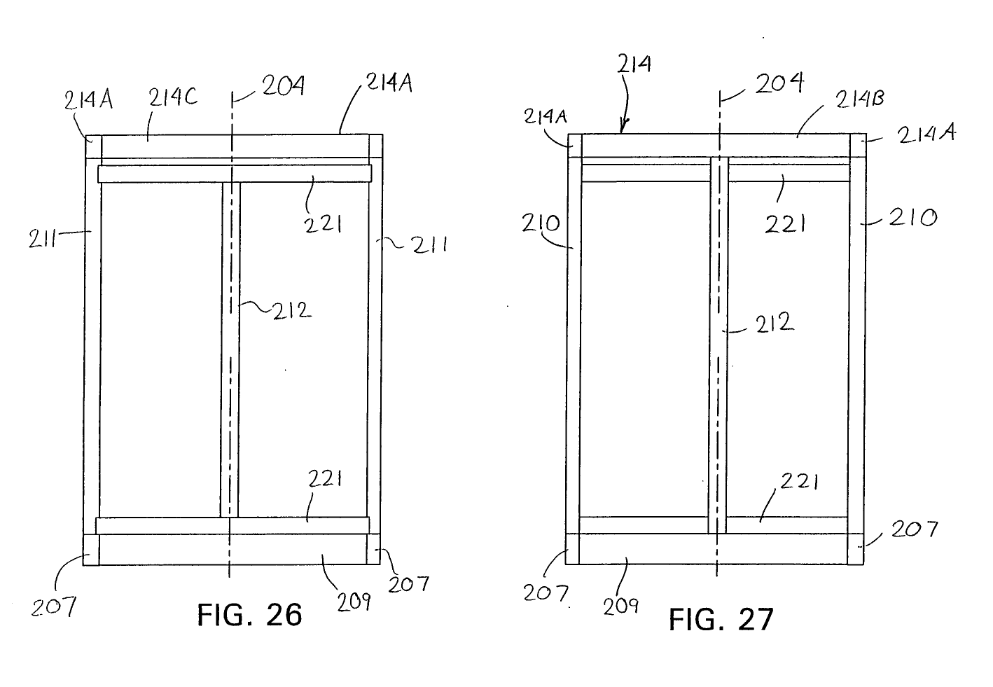

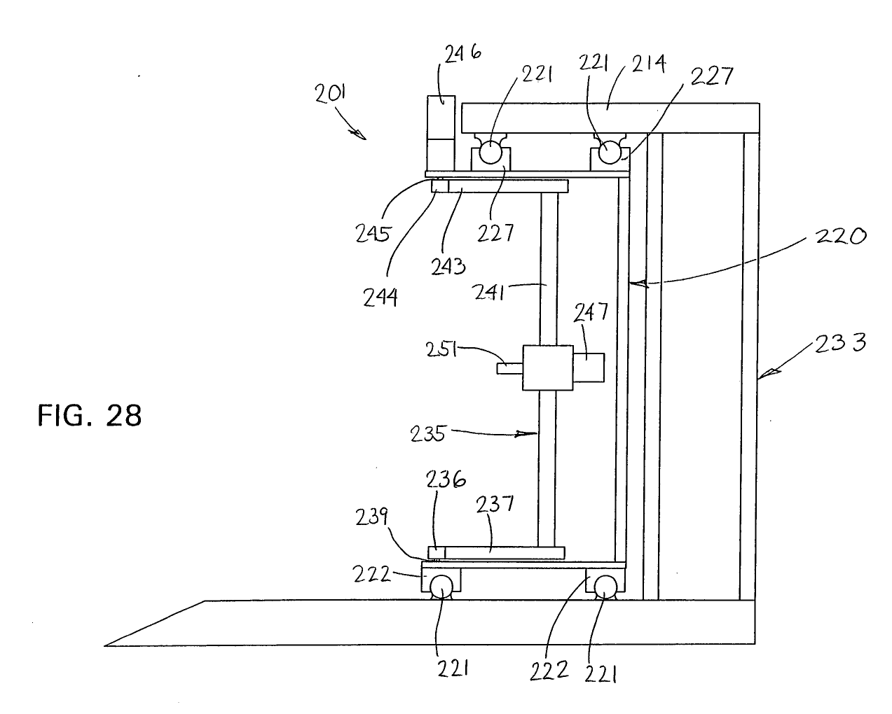

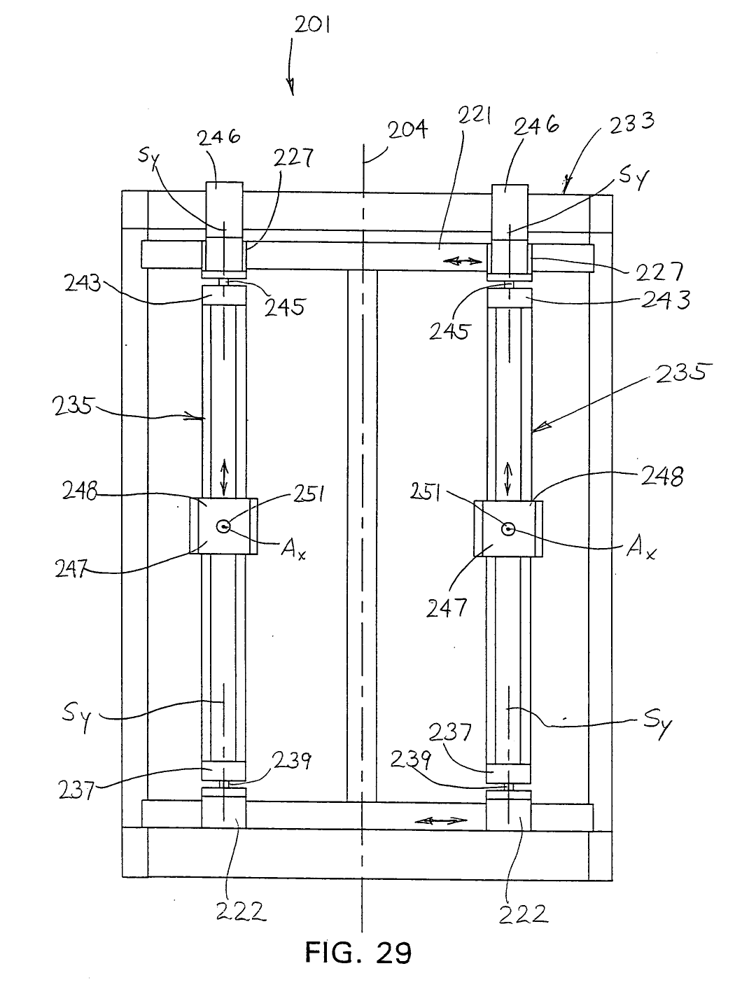

To accomplish adjustability of the width of the patient arm support assembly 202 as illustrated in FIGS. 18-27, a pair of horizontal travel assemblies 220 are slidably connected to linear bearing rails 221 mounted to the top side of the base 206 and the bottom side of the upper frame 214 to permit horizontal, width-wise sliding of the travel assemblies 220 toward and away from each other.

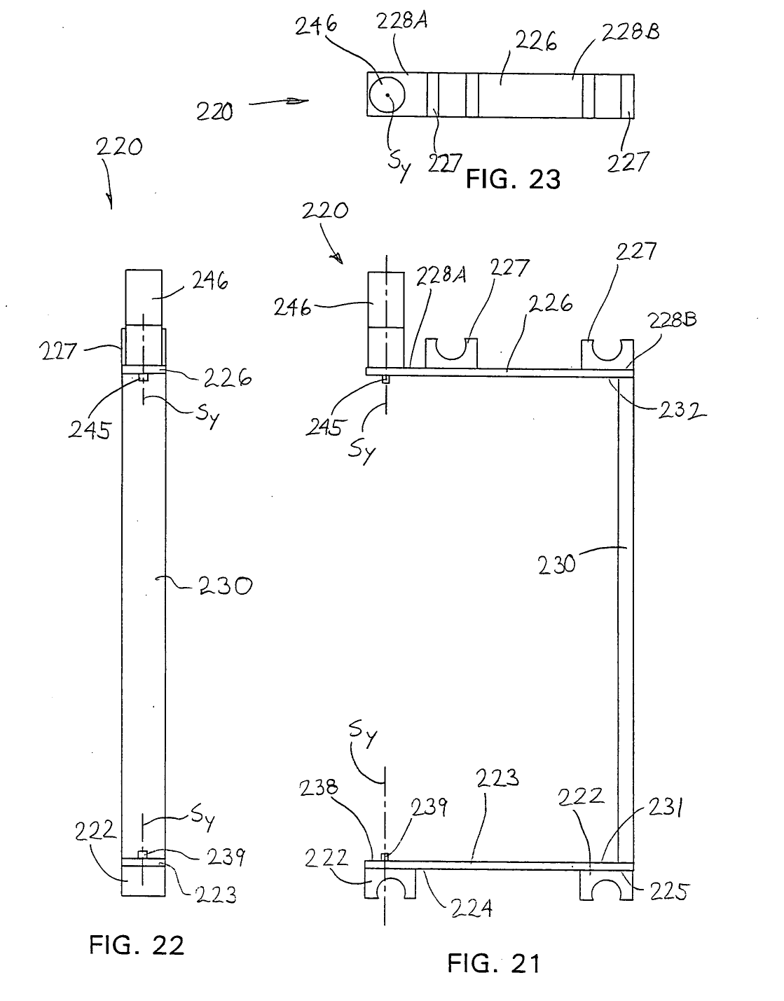

Referring to FIGS. 21-23, linear bearings 222 are mounted to the bottom side of a lower travel arm 223 at the front 224 and the rear 225 thereof. Linear bearings 222 are also mounted on the top side of an upper travel arm 226 at a mid point 227 and the rear 228. The linear bearings 222 are positioned about the linear rails 221 so as to be slidable.

Connecting the upper travel arm 226 and the lower travel arm 223 is a vertical column 230. The bottom of vertical column 230 is secured to the top of the lower travel arm 223 at the rear 231 and to the underside of the upper travel arm 226 at the rear 232. The horizontal travel assemblies 220 are free to move in a linear motion along the structural frame 233.

To emulate the rotation of the patient's arm about the shoulder, a pair of shoulder swing assemblies 235 are secured within the horizontal travel assembly 220 and are pivotable about a vertical axis. As seen in FIGS. 18-20, an outer front end 236 of the lower swing arm 237 is pivotally secured to horizontal travel assembly 220 at the outward end 238 of lower travel arm 223. At the outward front end 238 is affixed a cup and cone bearing assembly 239 which connects to the end 236 of the lower swing arm 237 and allows the lower swing arm 237 to pivot freely about the Sy axis. At the back end 240 of the lower swing arm 237, a vertical rail assembly 241 is securely fastened. The top end of vertical rail 241 is securely fastened to the back end 242 of the upper swing arm 243. The front end 244 of the upper swing arm 243 is firmly connected to an output shaft 245 of a servo drive assembly 246 on the travel assembly 220 so as to be rotated by the shaft 245.

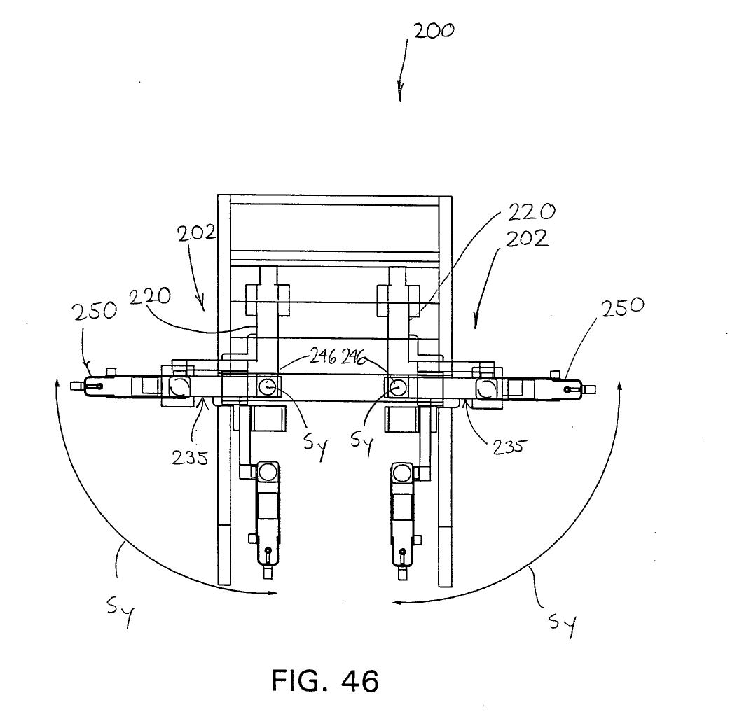

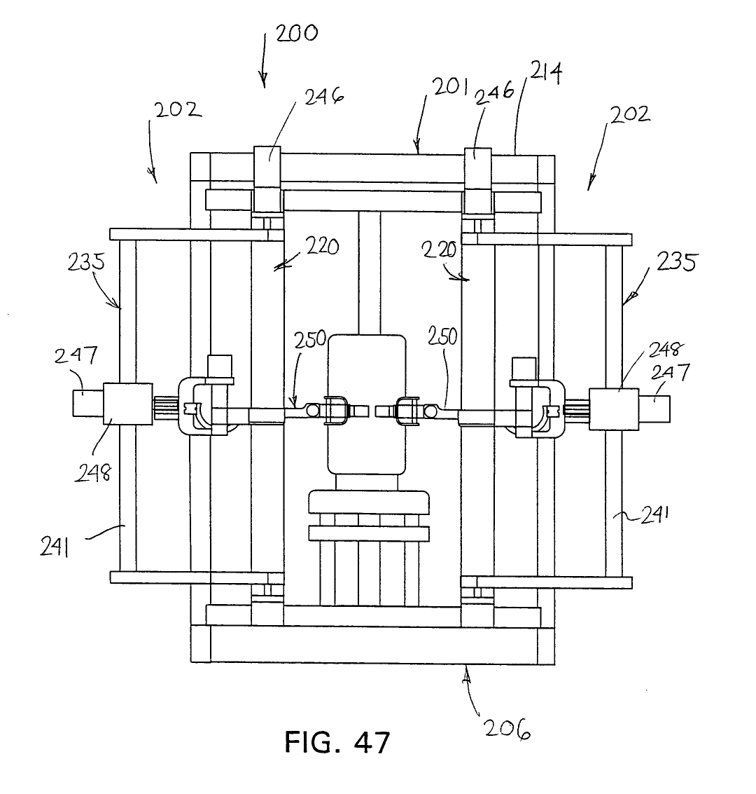

To effect controlled swinging movement of the shoulder swing assemblies 235, the servo drive assembly 246 is connected to each shoulder swing assembly 235 for rotation of the shoulder swing assembly 235 about the vertical axis Sy, as illustrated in FIG. 46. The servo drive assembly 246 cooperates with the remaining components of the drive system as will be discussed further herein.

Each shoulder swing assembly 235 includes an arm lift servo drive assembly 247. Fastened to each arm lift servo drive assembly 247 is a series of linear bearings 248. The linear bearings 248 are free to travel vertically about the vertical rails 241, allowing for height adjustment of the drive assembly 247.

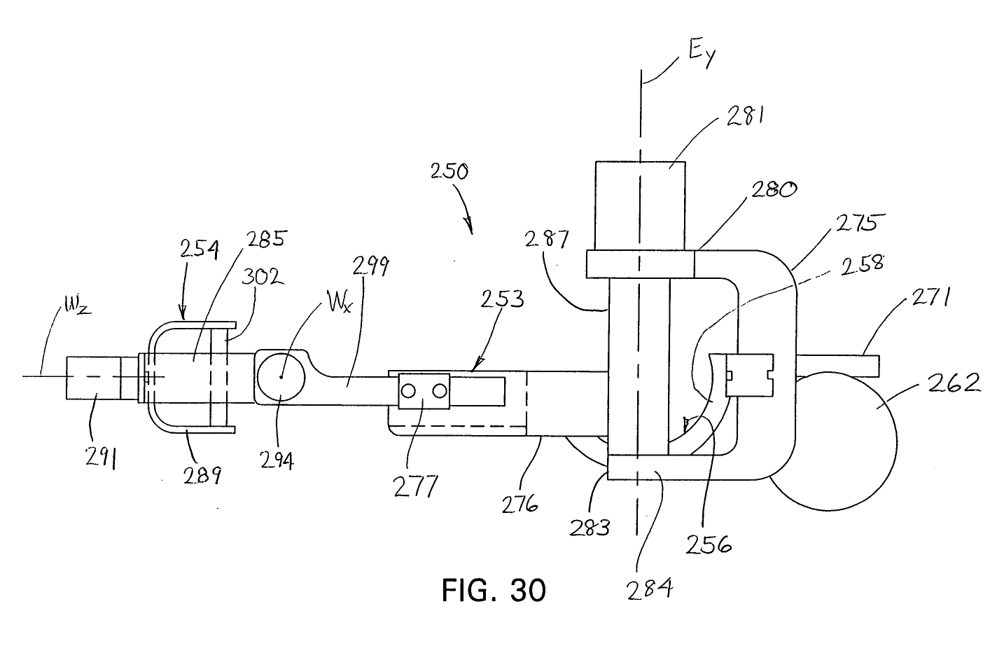

Referring to FIGS. 30-32, the patient arm support assembly 202 further includes a left and right arm support assembly 250 which are mounted to the left and right drive shafts 251 of the arm lift servo drive 247 so as to move vertically with the servo drive assembly 247 and also rotate about arm axis Ax. The arm support assemblies 250 are secured to the output shafts 251 of the arm lift servo drive assemblies 247 at right angles to the output shafts 251, extending outwardly therefrom. Each arm support assembly 250 is adapted to support the individual arms of the patient to effect controlled articulation of the shoulder, elbow and wrist joints of the patient's arm.

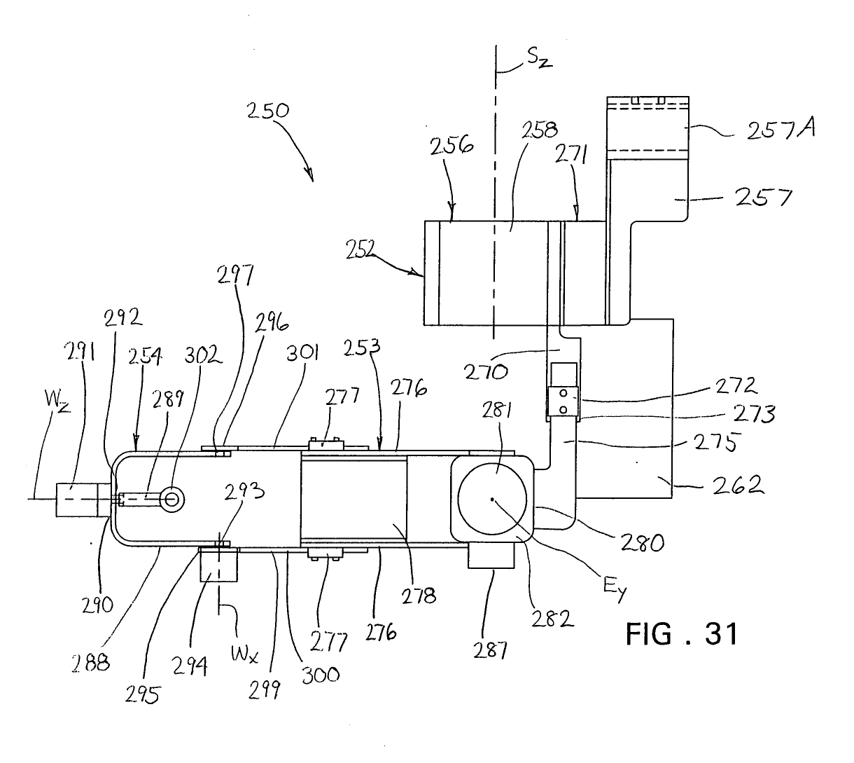

Referring to FIGS. 30 and 31, each arm support assembly 250 includes an upper arm sub-assembly 252, a lower arm or forearm sub-assembly 253 and a hand or wrist sub-assembly 254 which are all connected in series one to the other. The left and right arm support assemblies 250 are substantially identical except they are mirror images of each other such that the following description is primarily directed to the left arm support assembly 250, it being understood that the following discussion applies equally to the right arm support assembly 250.

More particularly, the upper arm sub-assembly 252 includes an upper arm support unit 256 adapted to support the uppermost portion of the patient's arm located between the shoulder and the elbow. The upper arm unit 256 includes a rigid base 257, which is mounted to the arm lift servo drive shaft 251 by a bracket 257A so as to support an upward facing upper arm shelf 258. To accomplish a rotary motion about the Sz axis, a rotary bearing assembly 260 is securely positioned to allow the rotary bearing assembly 260 to pivot about the circumference of the upper arm unit 256. A gear drive assembly 261 transfers the movement initiated by a shoulder rotary servo drive 262. Securely fastened to the shoulder rotary servo drive output shaft 263, is drive gear 264, which is in mesh with idler gear 265. Idler gear 265 drives the circumferential teeth 267 of the rotary bearing assembly 260 and completes the drive train for the Sz axis rotary motion.

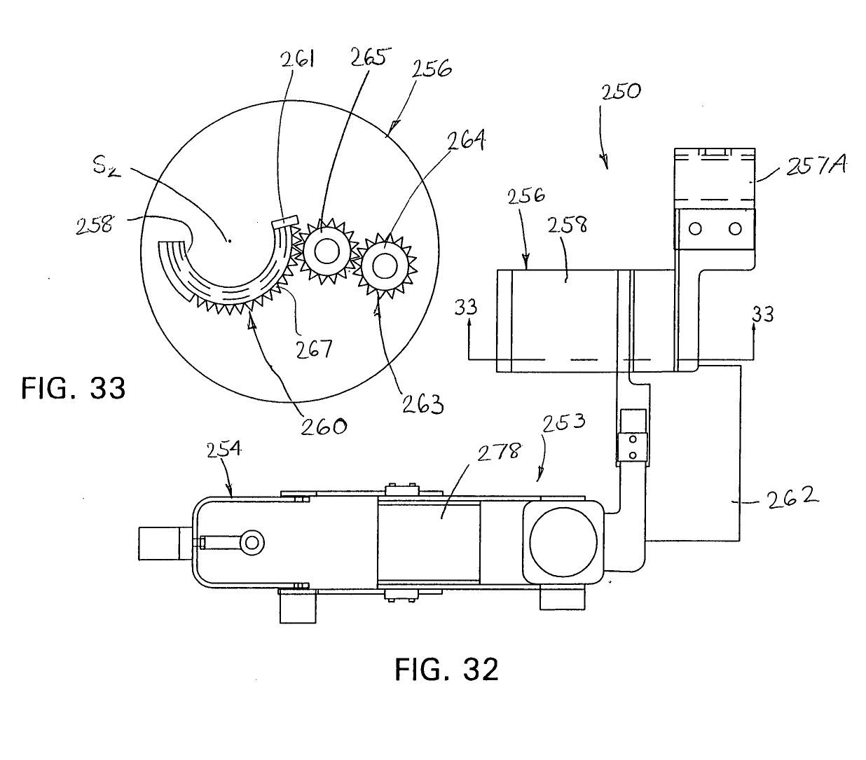

The upper arm shelf 258 is padded and preferably covered with vinyl or fabric covering. Further, the upper arm shelf 258 is shaped so as to have a generally concave depression extending longitudinally therealong. The depression opens upwardly as illustrated in FIG. 32 to receive the upper portion of the patient's arm above the elbow.

The upper arm sub-assembly 252 further includes an upper arm connector frame 270 and a mounting bracket 271 for the shoulder rotary servo drive 262. A forearm connector bracket adjustment clamp 272 is mounted on the outward end 273 of the upper arm connector frame 270. The forearm connector bracket adjustment clamp 272 secures the forearm connector bracket 275 while allowing for adjustment. The forearm connector bracket 275 is serially connected to and supports the forearm sub-assembly 253 thereon.

More particularly, each forearm sub-assembly 253 includes a rigid base 276. To permit connection of the wrist sub-assembly 254 to the forearm sub-assembly 253, C-shaped brackets clamps 277 are located on each side of the base 276.

A forearm shelf 278 is supported on the base 276, and as with the upper arm shelf 258, the forearm shelf 278 is a padded, covered component having a generally concave depression when viewed longitudinally from the end to receive the forearm of the patient downwardly therein.

While the upper arm shelf 258 and the forearm shelf 278 are illustrated and described having concave or recessed cross sections, it should be appreciated that other configurations may be employed. However, the recessed shape of the shelves 258 and 278 illustrated herein are believed to provide greater patient comfort and support than shelves having alternate configurations. By the upright sides of the shelves 258 and 278, the shelves 258 and 278 are able to confine and control movement and rotation of the arm.

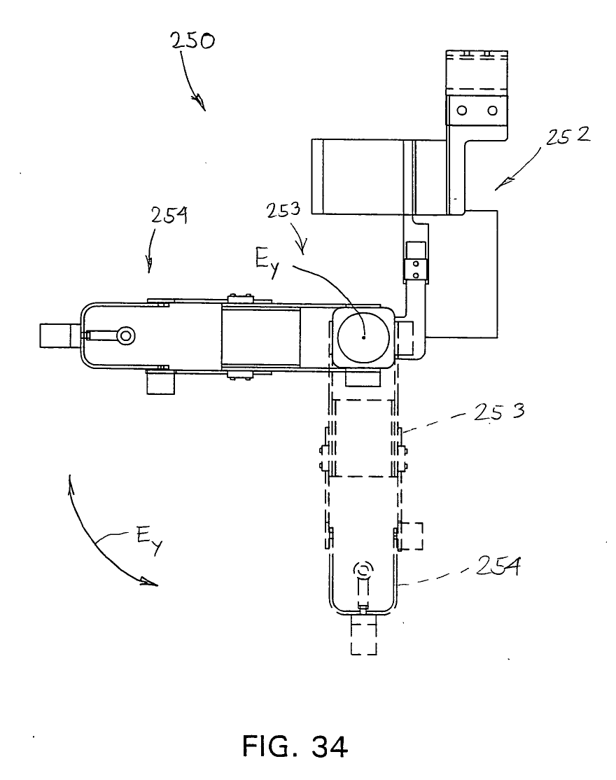

The forearm sub-assembly 253 also includes a connector frame 280 for connecting the forearm sub-assembly 253 to the above-described upper arm sub-assembly 252. The connector frame 280 is generally C-shaped and provides mounting provisions for the elbow pivot servo drive 281 on the top side 282. On the opposing side 283 is a pivot bearing assembly 284. Positioned on the interior of the connector frame 280 and secured to the output shaft 286 of the elbow pivot servo drive 281, is forearm pivot assembly 287. The lower end of forearm pivot assembly 287 is positioned to pivot with bearing assembly 284 about the Ey axis as seen in FIG. 34.

The arm support assembly 250 further includes the wrist sub-assembly 254. Each wrist assembly 254 includes a U-shaped outer frame 288 and a U-shaped inner frame 289 nested within the outer frame 288. Mounted on the outer most end 290 of the outer frame 288 is the wrist rotary servo drive 291. The inner frame, or wrist rotary handle bracket 289 is secured to the output shaft 292 of the wrist rotary servo drive 291. The servo drive 291 drives the handle bracket 289 about the Wz axis both inwardly (FIG. 39) and outwardly (FIG. 40).

Outer frame 288 is secured to the output shaft 293 of the wrist pivot servo drive 294 on the outboard side 295 and fixed about the pivot bearing 296 on the inboard side 297. Both the bearing assembly 296 and the servo drive 294 are located at the outermost end of the wrist bracket frame assembly 299. The wrist bracket frame assembly consists of two flat rectangular in shape frame bars 300 and 301. Frame bars 300 and 301 are both secured to forearm adjustment clamps 277 located on the sides of forearm base 276. On the outermost end of frame bar 300 is bearing assembly 296. On the outermost end of frame bar 301 is mounted servo drive 294.

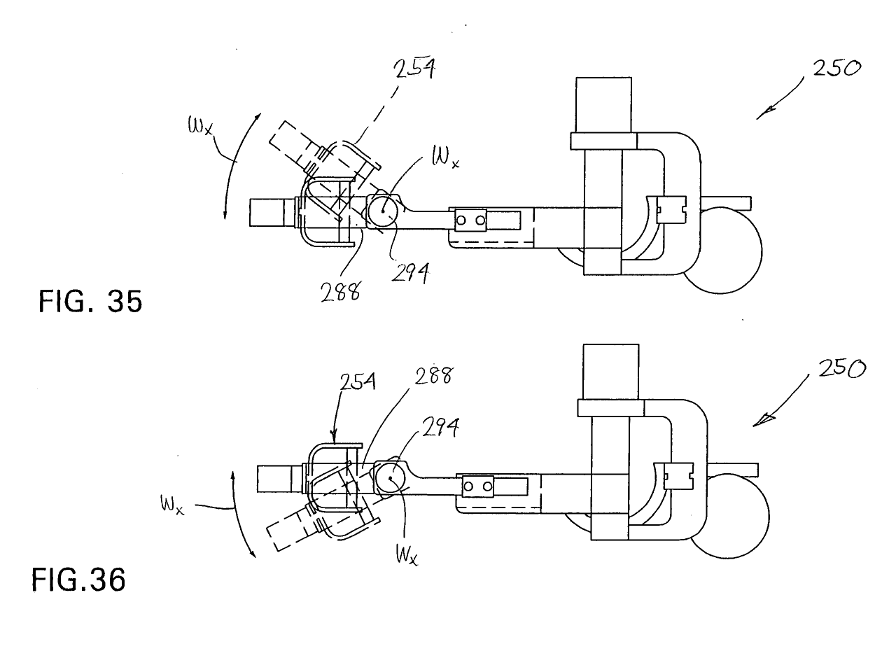

A handle 302 is fastened between the extended ends of the rotary handle bracket 289. The handle 302 is configured to provide a comfortable grip for the patient. Accordingly, the servo drive 294 can drive the bracket 288 both upwardly (FIG. 35) and downwardly (FIG. 36).

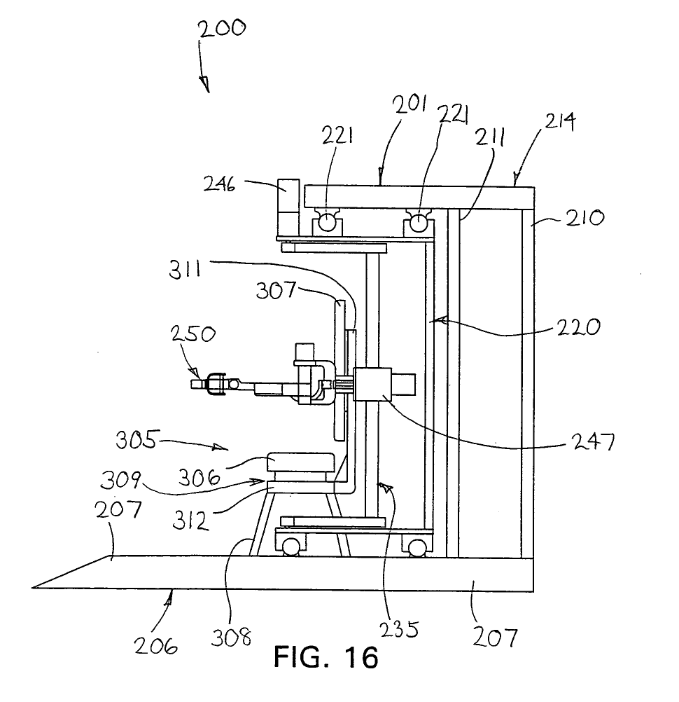

Returning to FIGS. 15 and 16, seat assembly 305 is located in front of vertical column 212, centered about the vertical axis 204. The seat assembly 305 consists of a bottom 306, a back 307, mounting legs 308, and an adjustable foundation 309. The back 307 is a conventional backrest, such as those incorporated into traditional weight and/or exercise machines. The back 307 preferably includes a rigid base having a padded front or patient contact surface. The seat back 307 is secured to the vertical columns 311 of seat mount 309.

The seat bottom 306 preferably includes a rigid base having a padded top or patient contact surface. The seat bottom 306 is fastened to the horizontal base 312 of the seat mount 309. Vertical legs 308 are used to secure the seat assembly 305 to the base assembly 201. It is desirable that the seat assembly 305 be adjustable for patient comfort.

Referring to FIG. 51, the control system 203 of the present invention includes a control unit 315. As schematically illustrated in FIG. 51, the control unit 315 includes a microprocessor 316, a data storage unit 317 and an operator interface 318. The operator interface 318 is preferably a touch screen interface, however, alternative interfaces, such as a typical personal computer may be substituted.

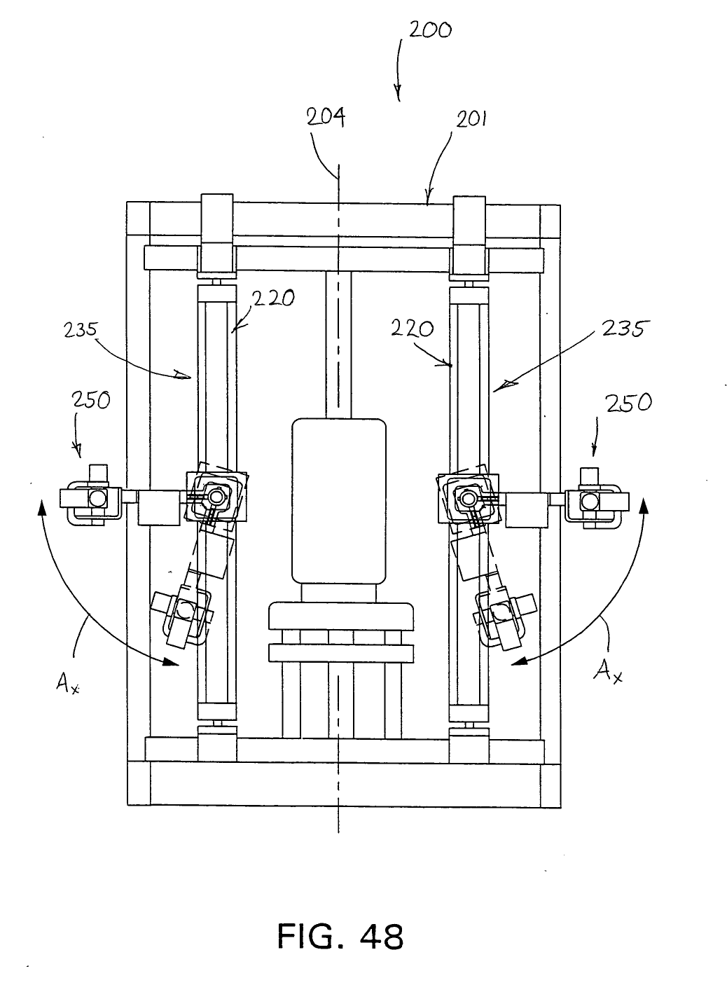

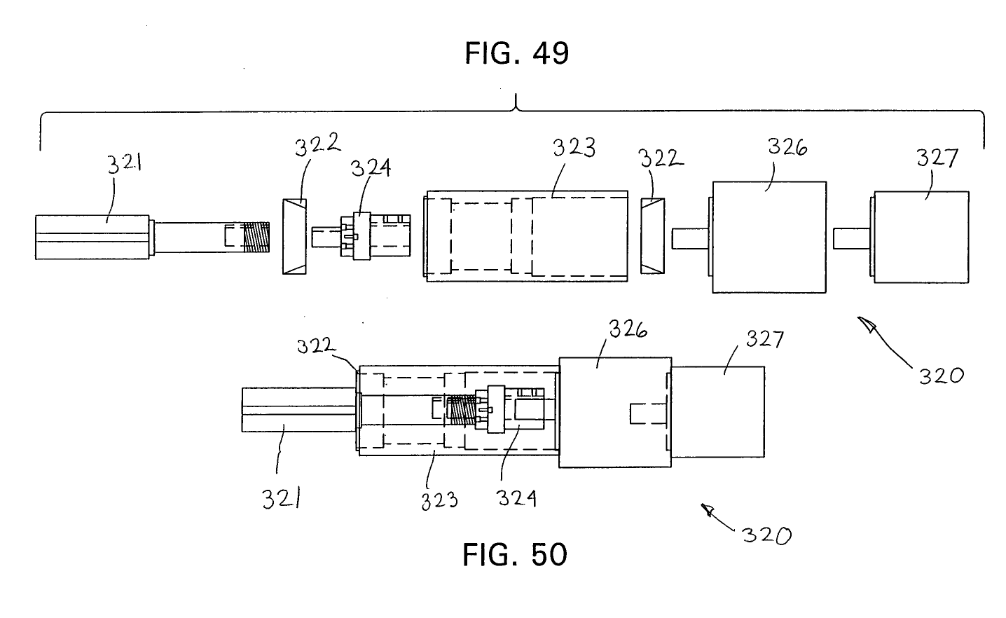

Referring to FIGS. 48-50, each servo drive assembly 246, 247, 262, 28.1, 291 and 294 is characterized by the typical servo drive example 320 illustrated in FIGS. 49 and 50. Each servo drive assembly will differ in physical characteristics to accommodate each location and application, but will be constructed to operate as illustrated in FIGS. 49 and 50.

A typical servo drive example 320 is constructed of serially connected components. The main drive shaft, or output shaft 321 is piloted through two servo drive bearings 322 to secure it in the bearing housing 323. The input shaft of the rotary torque sensor 324 is inserted into the interior end of the drive shaft 321. A speed reduction gearhead 326 is bolted to the bearing housing 323, while engaging its shaft into the free end of the rotary torque sensor 324. Servo motor 327 is then bolted onto the input of the speed reduction gearhead 326. As such, the torque sensors 324 in each of the servo drive assemblies therefore, measures and records force and resistance to movement by the patient. This information is used to measure patient status and progress, although this status and progress also may be measured by the position of components as in the first embodiment 10 or even the combination of force sensors and position sensors may be used.

### ASSEMBLY

To assemble the exercise therapy device 200, the stationary vertical post 210, 211 and 212 are welded to the base 206. Alternatively, these components may be secured to the base 206 through another suitable method, such as one or more bolts. The upper frame element 214 is welded to the vertical columns 210, 211, 212, or otherwise fixedly secured thereto.

Each horizontal travel assembly 220 is positioned within frame assembly 233 so that each linear bearing 222 or 227 is slidably engaged with each linear bearing rail 221 disposed above and below the travel assembly 220. The servo drives 246 are mounted with the output shafts 245 thereof vertically positioned and piloted within a recessed counter bore in the upper horizontal travel arm 226 so that the output shaft 245 passes through the bore near the end of the travel arm 226.

Each shoulder swing assembly 235 is positioned within or nested within each corresponding horizontal travel assembly 220 with the lower swing arm 237 typically connected to the bearing assembly 239. The upper swing arm 243 is permanently attached to the servo drive shaft 245 so that the shoulder swing assembly 235 swings or rotates therewith about the vertical axis Sy.

The patient seat support assembly 305 is connected to the top side of the frame element 233 in such a manner that would allow it to be removable, such as by pinning the bottom of the legs 308 to the frame 233.

Each servo drive 247 is bolted to the vertical linear bearings 248 which are then free to slide vertically on the vertical rails 241 of the shoulder swing assembly 235. The horizontal output shaft 251 is positioned horizontally with the end of the shaft 251 projecting forwardly. The left and right arm assemblies 250 are next constructed. Since each arm assembly 250 is constructed in an identical manner, assembly of only the left arm assembly 250 is described in detail herein.

The left upper arm sub-assembly 252 is constructed by securing the upper arm shelf assembly 256 and the upper arm connector frame 270 to the arm support mounting bracket 271 by bolting or other suitable fasteners.

The forearm sub-assembly 253 is constructed by welding, or other suitable fastening methods, the forearm connector bracket 275 to the forearm sub-assembly connector frame 280. Servo drive 281 is positioned on the fore-arm sub-assembly connector frame 280 such that it is piloted in a counter bored pilot bore, with the output shaft 286 passing there through in a vertical orientation. The servo drive 281 is secured in place with bolts.

The fore arm shelf 278 is next mounted to the fore arm connector bracket 276 by bolting or welding. The free ends of the fore arm connector bracket 276 are positioned within the interior of the forearm sub-assembly connector frame 280, with the bottom end piloted about bearing assembly 284. The top side of the free end of the forearm connector bracket 276 is secured to the output shaft 286 of the servo drive 281 so as to rotate therewith.

The wrist support sub-assembly 254 is constructed by bolting the servo drive 294 into the counter bore of the outboard side of the wrist bracket frame 299. The output shaft 293 thereof is piloted through a bore and oriented in a horizontal position. The wrist pivot frame 288 is now positioned within the interior of the wrist bracket frame 299, with the bearing connection 297 about the bearing assembly 296. The opposing side is secured to the output shaft 293 of the servo drive 294 so as to rotate therewith.

The additional servo drive 291 is bolted to the counter bore 290 such that the output shaft 292 is horizontal and projects inwardly. The wrist rotary handle assembly 289 is securely fastened to the output shaft 292 so as to also rotate therewith.

To complete the arm support assembly 250, the free ends of the forearm connector bracket 275 are inserted and passed through the forearm bracket adjustment clamps 272 and secured by bolts or other conventional locking methods. The wrist sub-assembly is now connected to the forearm sub-assembly by inserting the free ends of the wrist bracket frame 299 in and through the wrist bracket extension clamps 277, where it is secured by bolts or other conventional locking methods.

The complete arm support assembly 250 is now mounted to the frame assembly 201, by sliding the bore of the arm assembly mounting clamp 257 over the output shaft 251 and locking it securely by bolts or lock screws.

The control system 203 is connected to the remainder of the exercise therapy device 200. For instance, it might be desirable to secure the control unit 315 to the frame itself such that the operator interface 318 is accessible from the front and within the patient's view. Alternatively, an attendant may prefer to have the control unit 315 mounted remotely, with the operator interface 318 mounted on a desk or other remote location.

### OPERATION OF SECOND EMBODIMENT

To use the exercise therapy device 200 of the first embodiment, the patient support seat assembly 305 is adjusted to the desired vertical position for the patient. The patient is seated on the patient support seat 306. If desired, the patient may be secured to the seat portion thereof by a waist belt or strap.

Once the patient is appropriately seated, one or both of the patient's arms are positioned in the associated arm support assemblies 250. As each arm is secured to the respective arm support assembly 250 in an identical manner, the positioning of only one arm will be described.

The patient's arm is positioned over the associated arm support assembly 250 so the patient's upper and lower arms are received in the respective upper and lower arm shelves 258 and 278. The patient's arm may be secured to the upper and/or lower arm shelves 258 and 278, such as by straps, if desired. The patient's hand is wrapped around the handle 302 and secured thereto by a strap.

Once the patient is secured to the therapy device 200, the attendant programs the control unit 315 to begin the appropriate therapy sequence in the desired operational mode. At least five operational modes are contemplated by the present invention. The appropriate operational mode will be determined based on the current treatment needs of the patient. Each treatment mode will involve movement of at least one of the patient's arms about one or more of the shoulder, elbow and wrist axes Ax, Sy, Sz, Ey, Wx and Wz. Movement of the patient's arm about each of these axes will be described below.

To move the patient's left arm about the vertical first shoulder axis Sy, the microprocessor 315 generates an appropriate energization signal. The energization signal is transmitted to the transducer in the shoulder servo motor 246. Based on this energization signal, the transducer actuates the servo motor 246. When the servo motor 246 is actuated, the shaft 245 is rotated about the vertical axis Sy. The arm support assembly 250, and thus the patient's arm, is rotated about the axis Sy to the position illustrated in FIG. 46.

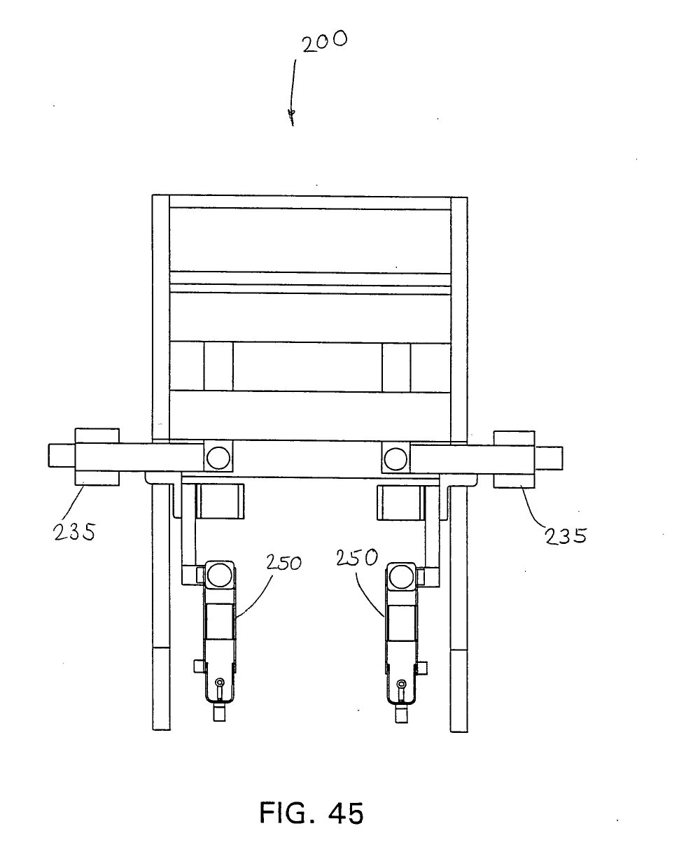

The microprocessor 315 generates control signals which are transmitted to the transducer representative of the angular distance the patient's arm is to be pivoted outwardly and inwardly about the axis Sy and the number of times the arm is to pivot about the axis Sy. Once the arm is rotated about the axis Sy the desired number of times, the microprocessor 315 transmits a control signal to the transducer to return the arm support 250 to the rest position of FIG. 45. If the patient's treatment is completed, or if the patient's arm will not be rotated about the axis Sy for the remainder of the treatment session, the control signal may include a command to de-activate the shoulder servo motor 315.

Movement of the patient's left arm about the longitudinal second shoulder axis Sz (FIG. 33) is initiated by an energization signal which is generated by the microprocessor 305. The energization signal is transmitted to the shoulder servo motor 262 transducer, which actuates the servo.motor 262. The servo motor shaft 263 is rotated about the axis Sz. The gear ring 264 on the shaft 263 drives the idler gear 265, which drives the teeth 267 on the upper arm support shelf 258 to rotate the left arm support assembly 250 about the axis Sz. Rotation of the left arm support assembly 250 about the axis Sz results in a corresponding rotation of the patient's left arm about the axis Sz to the raised position illustrated in FIG. 42 or the lowered position illustrated in FIG. 43.

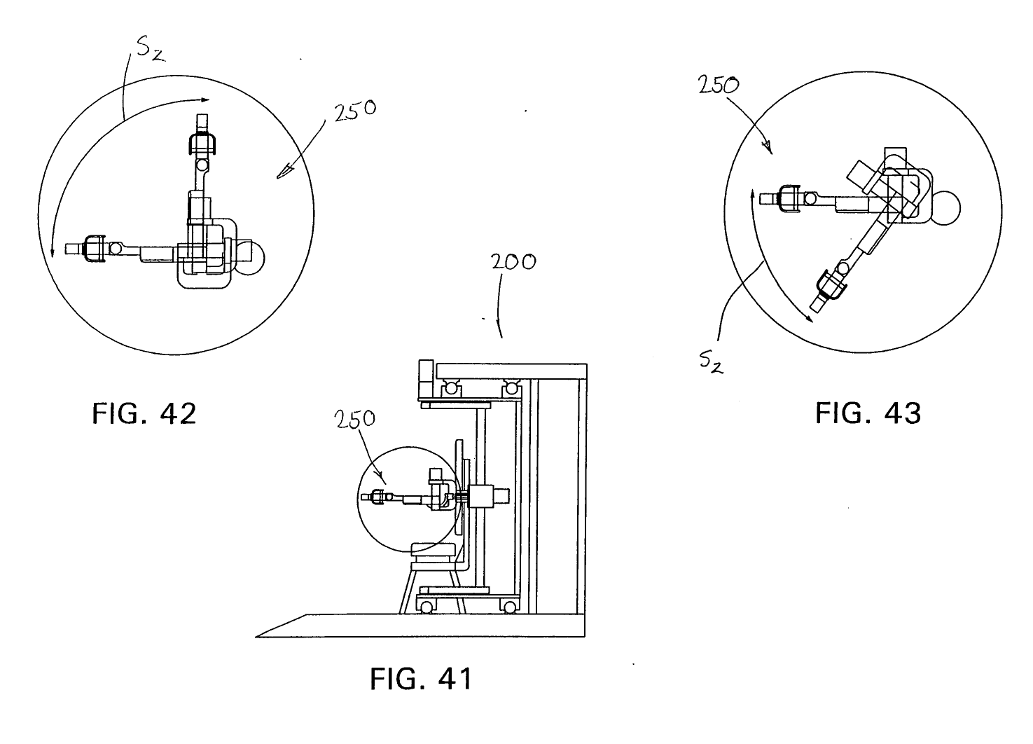

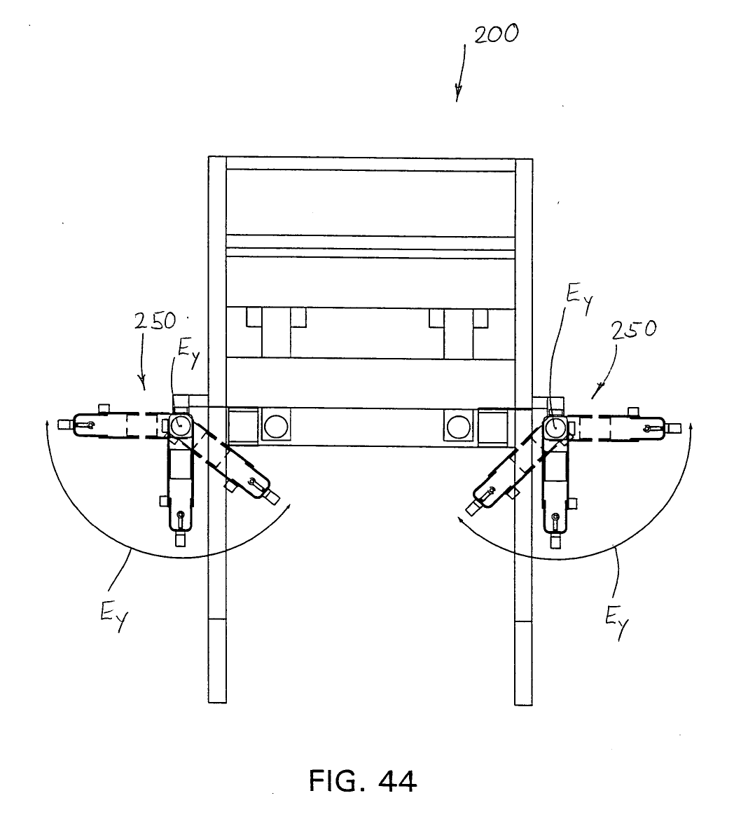

The microprocessor 315 generates and transmits to the transducer continuous control signals representative of the angular distance the patient's left arm is to be pivoted about the axis Sz through a limited angular distance and the number of times the patient's left arm is to be rotated back and forth about the axis Sy. Once the patient's left arm is partially rotated about the axis Sz the desired number of times, the microprocessor 315 generates a new control signal. This control signal is transmitted to the transducer. In response, the transducer instructs the servo motor 262 to return the arm support assembly 250 to the rest position (FIG. 41). If the patient's treatment is completed, or if the patient's left arm will not be rotated about the axis Sz for the remainder of the treatment session, the control signal may include a command to de-activate the shoulder servo motor 262.

Referring now to FIG. 48, to move the patient's left arm about the third shoulder axis Ax, the microprocessor 315 generates a first energization signal which is transmitted to the transducer in the shoulder servo motor 247. The transducer actuates the servo motor 247 in response to the received energization signal. The servo motor shaft 251 (FIGS. 18 and 19) is rotated about the vertical axis Ax. As the shaft 251 rotates, the arm support assembly 250, and thus the patient's corresponding right or left arm, rotates about the AX axis as seen in FIG. 48.

The microprocessor 315 then generates a second energization signal which is transmitted to the transducer in the shoulder servo motor 247. The shoulder servo motor 247 is actuated and the associated shaft 251 is rotated with respect to the horizontal axis Ax which thereby rotates the arm through a limited angular distance. Rotation of the arm support assembly 250 about the respective axis Ax results in a corresponding rotation of the patient's arm through an angular distance about the axis Ax to the lowered position illustrated in FIG. 48.

The microprocessor 315 transmits continuous control signals to the shoulder servo motor 247 transducer. These signals represent the angular distance the patient's arm is to be pivoted about the axis Ax and the number of times the arm is to be pivoted. Once the patient's arm is rotated about the axis Ax the desired number of times, the microprocessor 315 generates a new control signal. This control signal is transmitted to the shoulder servo motor transducer. In response to this new received control signal, the transducer instructs the servo motor 247 to return the arm support assembly 250 to the rest position. If the patient's treatment is completed, or if the patient's arm will not be rotated about the Ax axis for the remainder of the treatment session, a control signal may include a command to de-activate the shoulder servo motors 247.

To move the patient's left lower arm with respect to the left upper arm about the transverse elbow axis Ey, the microprocessor 315 generates an energization signal which is transmitted to the transducer in the elbow servo motor 281. The transducer actuates the servo motor 281 in response to the received energization signal, causing the servo motor shaft 286 to rotate about the axis Ey. Rotation of the shaft 286 results in a corresponding pivoting of the forearm base 276 about the axis Ey. Rotation of the forearm base 276 results in a corresponding rotation of the patient's lower arm about the axis Ey with respect to the upper arm to the position illustrated in FIG. 34.

Continuous control signals are transmitted by the microprocessor 315 representing the angular distance and the number of rotations of the left lower arm with respect to the left upper arm. Once the patient's lower arm is rotated about the axis Ey the desired number of times, the microprocessor 315 generates a new control signal and transmits this control signal to the transducer. The transducer instructs the servo motor 315 to return the arm support assembly 250 to the rest position (FIG. 31). If the patient's treatment is completed, or if the patient's arm will not be rotated about the axis Ey for the remainder of the treatment session, the control signal may include a command to de-activate the servo motor 281.

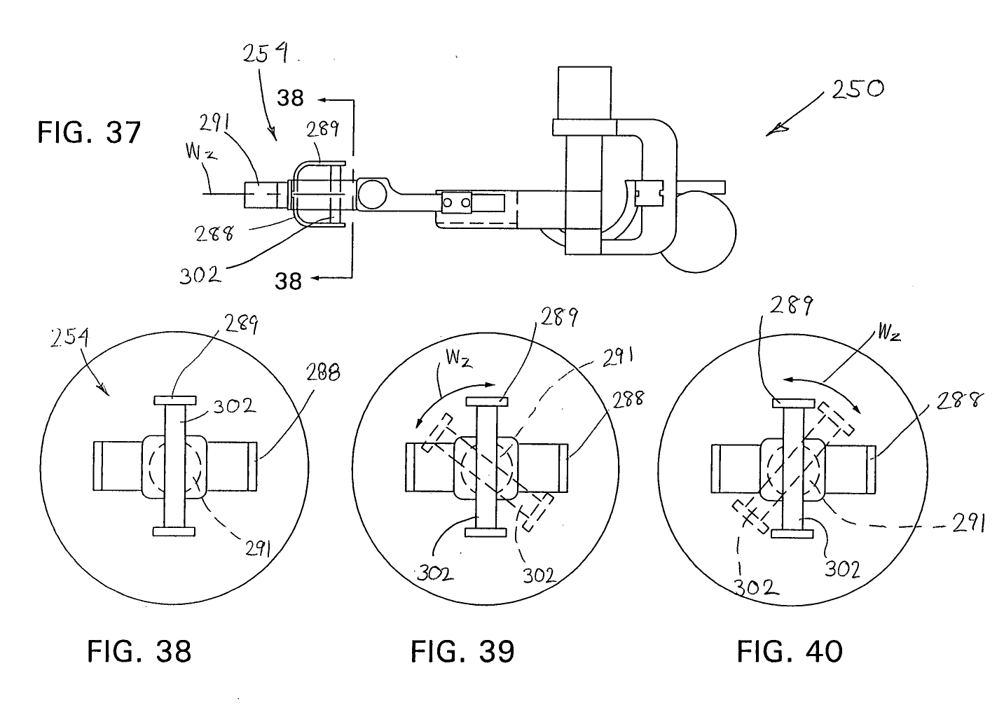

Movement of the patient's hand with respect to the associated lower arm about the wrist axes Wx and Wz as illustrated in FIGS. 35-40, is initiated by an energization signal generated by the microprocessor 315. This energization signal is transmitted to the transducer in the appropriate wrist servo motor 291 and 294.

When movement of the hand about the transverse wrist axis Wx is desired, as illustrated in FIGS. 35 and 36, the energization signal is transmitted to the transducer in the wrist servo motor 294. The transducer actuates the servo motor 294, causing the shaft 293 to rotate about the axis Wx. Rotation of the shaft 293 causes a corresponding rotation of the wrist support 254, and thus the patient's hand, about the axis Wx.

Finally, when movement of the patient's left hand about the longitudinal wrist axis Wz is desired, as illustrated in FIGS. 38-40, the energization signal is transmitted to the transducer in the wrist servo motor 291. The servo motor 291 is actuated by the transducer to rotate the shaft 292 about the axis Wz. As the shaft 292 rotates, the inner frame 289 and the handle 302 rotate a limited angular distance identified by reference arrows in FIGS. 39 and 40. This rotation of the handle 302 results in rotation of the patient's hand about the axis Wz.

Continuous control signals are transmitted by the microprocessor 315 to the appropriate transducer for continued movement. These control signals represent the angular distance the hand is to be pivoted about the relevant axis Wx or Wz and the number of times the hand is to be pivoted about that axis. Once the patient's hand is rotated about the relevant axis the desired number of times, the microprocessor 315 generates a new control signal. This control signal is transmitted to the appropriate transducer and instructs the transducer to control the servo motor 291 or 294 to return the handle 302 to the rest position (FIG. 38). If the patient's treatment is completed, or if the patient's hand will not be rotated about the axis for the remainder of the treatment session, the control signal may include a command to de-activate the corresponding servo motor 291 or 294.

As indicated previously, the exercise therapy device 10 may be operated in one of five primary operational modes to treat a patient.

The first operational mode is the single or multiple axis “repetitive motion mode”. In this operational mode, a single joint is exercised while the remaining joints are held stationary. For instance, if the patient's left wrist is stricken, the treating attendant may choose to move the left wrist with respect to one or two of the wrist axes. The attendant enters the following information at the interface: the wrist to be exercised, the axes about which the wrist will be exercised, the angular range of motion through which the wrist will be moved, the speed at which the wrist will be moved and the number of repetitions. The microprocessor 315 then generates one or more control signals based on the input information. The control signals are transferred to the appropriate left wrist servo motor or motors 291 or 294. Each appropriate servo motors is actuated in the manner described above to move the desired wrist about the relevant axis, as instructed.

The second operational mode is the single axis “parallel motion mode”. In this operational mode, both of the patient's arms are moved in mirrored relation. Thus, if the attendant determines that the patient's treatment should focus on the elbow, the following information is entered: both elbows in parallel motion, movement of the lower arms with respect to the upper arms about the elbows, the range of motion through which the lower arms will be moved about the elbow, speed of movement and the number of repetitions. The microprocessor 315 then generates the appropriate control signals to activate the elbow servo motors 281 for the programmed treatment.

The third operational mode is the “coordinated series motion mode”. In this operational mode, the patient's stricken arm is repeatedly moved through a series of moves about one or more of the axes. Thus, if the patient has a stricken left arm, that limb will be moved through a series of movements about some or all of the axes. For example, the left arm could be guided through a series of movements in which the shoulder, elbow and wrist are moved sequentially about each of the seven axes. For operation in this mode, the attendant either manually inputs the series of movements for the left arm to be moved through or selects from one of a number of stored programs. The microprocessor 315 then activates, controls, and deactivates the appropriate servo motors to move the stricken arm according to the desired treatment program.

The fourth operational mode is the “series parallel motion mode”. This mode of operation is similar to the coordinated series motion mode. However, in this mode of operation, both arms are guided through the series of moves based on either input from the attendant or a stored exercise program.

The fifth operational mode is the “strength measurement motion mode”. In this mode of operation, the strength of one or both of the patient's arms is measured and recorded. In this mode of operation, the patient moves one arm about one or more of the axes at the direction of the attendant. This mode of operation could be useful to measure the progress of a stroke victim who is regaining the use of a stricken right arm. In this operational mode, the sensors 324 detect the rotary torque required to move one or more of the hand, lower arm and/or upper arm about the associated wrist, elbow and shoulder axes. For instance, if the patient moves his right lower arm about the elbow axis Ey, the rotary torque sensor 324 detects the resistance and generates a detection signal indicative of this information. The detection signal is transmitted to the microprocessor 315 by the sensor 324. The microprocessor 315 receives the detection signal and generates a strength data signal which is transmitted to the attendant interface 318. In addition, this strength data signal may also be transmitted to the control unit data store 317 so information relating to the patient's progress is maintained within the control unit. Each movement by the patient is similarly detected by the appropriate sensor 324, which transmits information to the microprocessor 316 for use by the attendant.

In addition to the above, treatment in this operational mode may include introduction of resistance to patient movement. Once the patient has recovered beyond a predetermined threshold, the patient may be asked to work against the device to move a recovering arm to a particular orientation. For instance, if the attendant wants to evaluate the strength of the patient's right wrist, he or she inputs a direction for the exercise therapy device 200 to move the patient's hand counterclockwise about the wrist axis Wx. The microprocessor 315 then generates a signal instructing the servo motor 294 to rotate the shaft 293, and therefore the handle 302, about the wrist axis Wx in the counterclockwise direction and to maintain that position. The patient is then instructed to attempt to return the handle 302 to the rest position, or to rotate the handle 302 beyond the rest position in the clockwise direction. The wrist sensor 324 detects the resistance of the handle 302, and therefore the patient's hand, in the clockwise direction about the wrist axis Wx and generates a detection signal indicative of this movement information, which signal is transmitted to the microprocessor 315. The microprocessor 315 generates a resistance data signal that is transmitted to the attendant interface 318 and, if desired, to the control unit data store 317. This procedure may be repeated for the hand about the same axis or about one or both of the remaining axes. Similarly, this procedure may be repeated for the patient's lower and upper arms.

### MODIFICATIONS

It will be understood that while the servo motors and associated sensors are illustrated as separate components, it is preferred that servo motors be used with the appropriate sensor components incorporated therein. Such servo motors are known and further disclosure thereof is not required. Other modifications such as those described herein relative to the first embodiment are also applicable to the second embodiment.

Thus, although particular preferred embodiments of the present invention have been disclosed in detail for illustrative purposes, it will be recognized that variations or modifications lie within the scope of the present invention and do not depart from the spirit of the invention, as set forth in the foregoing description and drawings, and in the following claims.

What is claimed is:

1. A repetitive motion exercise therapy device for rehabilitating one or more limbs of a patient, said device comprising:
a frame configured to support a patient thereon;
at least one limb support assembly supported on said frame which is adapted to support a respective limb of a patient and articulate the limb about one or more limb joints thereof, said limb support including a first upper limb support member pivotally attached to said frame at an upper pivot location disposed proximate a first limb joint, and a second intermediate limb support member pivotally connected to said upper limb support member at a second pivot location disposed proximate an intermediate limb joint, and a third lower limb support member pivotally attached to said intermediate limb support member at a third pivot location proximate a third lower limb joint;
wherein one or more pivot axes extend through each of said first, second and third pivot locations to permit articulation of the joints of the limb about one or more of said pivot axes to effect rehabilitation thereof;
a first drive unit connected to said upper limb support member which pivots said first limb support member about at least one of said pivot axes at said upper limb joint;
a second drive unit connected to said intermediate limb support member to pivot said intermediate limb support member about at least one said pivot axis at said intermediate limb joint;
a third drive unit connected to said lower limb support member to pivot said lower limb support member about at least one said pivot axis at said lower limb joint; and
a control unit which controls said first, second and third drive units to move said upper, intermediate and lower limb support members through any of said pivot axes to articulate one or more of said limb joints of said limb.

2. The device according to claim 1, wherein said first, second and third drive units include sensors which detect the operation of said first, second and third drive units to control movement of said first, second and upper, intermediate and lower limb support members.

3. The device according to claim 2, wherein said control unit includes a microprocessor configured to receive data signals from said sensors and generate command signals for said first, second and third drive units.

4. The device according to claim 1, wherein said limb is an arm having a shoulder joint, elbow joint and wrist joint, and said limb support assembly is configured to support said arm of the patient, said upper limb support member being adapted to support an upper arm of the patient, said intermediate limb support member being adapted to support the forearm of the patient, and said lower limb support member being adapted to support the wrist and hand of a patient, said pivot axes comprising at least one shoulder axis for the shoulder joint, at least one elbow axis for the elbow joint and at least one wrist axis for the wrist joint.

5. The device according to claim 4, wherein said lower limb support member includes a hand grip which is movably supported to articulate about at least two said wrist axes, said third drive unit comprising a first wrist motor for moving said hand grip relative to one said wrist axis and a second wrist motor for moving said hand grip relative to another said wrist axis, said control unit operating said first and second wrist motors simultaneously and/or independently of each other.

6. The device according to claim 1, wherein said control unit includes an operator interface which prompts a device operator for inputs to control a sequence of operation of said first, second and third drive units.

7. The device according to claim 1, wherein said device comprises two said limb support assemblies adapted to support both arms of a patient, said control unit configured to move said limb support assemblies independently of each other or simultaneously, and to move each said limb support assembly to articulate said upper, intermediate and lower limb support members through multiple sequences of movement about said pivot axes.

8. The device according to claim 1, wherein said device comprises a swing arm which is pivotally connected to said frame so as to pivot about a vertical axis, said limb support assembly being supported on said swing arm so as to be movable therewith wherein said vertical axis of said swing arm defines one said pivot axis at said first pivot location for said first limb joint.

9. The device according to claim 1, wherein said limb support assembly is movable sidewardly relative to said frame to adjust a lateral position of said limb support assembly relative to a patient.

10. A repetitive motion exercise device for articulating the limb joints of a patient undergoing therapy, said device comprising:
a frame having a patient support assembly attached to said frame to support a patient thereon, said frame further including frame members pivotally supported on said frame at respective frame pivot locations and first driver units which are operably connected to said frame members to effect rotation of said frame members;
a limb support assembly mounted respectively on said frame members so as to be movable therewith, said limb support assemblies extending from said frame members and being pivotally secured thereto at respective support pivot locations, second drive units being operably connected to said limb support assemblies to effect movement of said limb support assemblies at said support pivot locations; and
a controller operably connected to said first and second drive units, said controller being configured to operate each said first drive unit to pivot said frame members with respect to said frame about a first pivot axis extending through said frame pivot location and to operate each said second drive unit to pivot said limb support assemblies with respect to said respective frame members about a second pivot axis extending through said first support pivot location.

11. The device according to claim 10, wherein each of said limb support assemblies comprises a plurality of limb support sections pivotally attached to each other at respective second pivot attachment points, third drive units being associated with each of said second pivot attachment points to pivot a respective one of said limb support sections about said respective second pivot attachment point; and said controller being operatively connected to said first, second and third drive units to operate said first, second and third drive units to pivot said limb support sections about respective pivot axes extending through said respective pivot attachment points, said support pivot locations and said frame pivot locations.

12. The device according to claim 11, wherein each said limb support assembly comprises three said limb support sections which are respectively adapted to support the upper arm, forearm and wrist of the limb of a patient.

13. The device according to claim 12, wherein one of said third drive units is provided for each of said limb support sections to effect pivoting movement of said respective limb support section about one or more pivot axes independently of the other of said limb support sections.

14. The device according to claim 13, wherein said controller is operatively connected to all of said drive units to independently operate the drive units and effect articulation of the patient's limb about one or more joints thereof and about one or more pivot axes associated with each said joint.

15. A repetitive motion exercise therapy device for rehabilitating a limb of a patient by articulating the limb about a plurality of limb joints associated therewith, said device comprising:
a frame;
at least one limb support assembly supported on said frame, said limb support assembly comprising a plurality of limb support sections which are joined one attached to the other to support multiple sections of a patient's limb along the length of the limb between the limb joints, said limb support sections being joined one to the other by a pivot connection wherein each said pivot connection corresponds to a limb joint, said limb support assembly further including a drive unit associated with each pivot connection to effect articulation of one limb support section relative to an adjacent said limb support section for articulating the limb joint associated therewith; and
a control unit operably connected to the drive units for independently or simultaneously operating said drive units to effect controlled manipulation of the limb support sections about the pivot connections.

16. The device according to claim 15, wherein said pivot connections correspond to a shoulder joint, an elbow joint and a wrist joint of a limb and effect articulation about at least one pivot axis for each said limb joint.

17. The device according to claim 16, wherein said pivot connection associated with said shoulder joint permits movement of an upper one of said limb support section about a plurality of pivot axes.

18. The device according to claim 17, wherein said shoulder pivot axes comprise a vertical shoulder axis, a horizontal shoulder axis extending forwardly and a longitudinal arm axis extending longitudinally along the length of an upper arm section.

19. The device according to claim 16, wherein one said limb support section comprises an intermediate limb support section which is pivotally connected to a distal end of said upper arm section and defines a vertical elbow pivot axis.

20. The device according to claim 19, wherein said limb support section comprises a wrist support section which is pivotally connected to said intermediate support section by the associated pivot connection which said associated pivot connection defines a horizontal pivot axis extending sidewardly and a horizontal pivot axis extending longitudinally along the wrist.
